(19) United States
(12) Patent Application Publication
(10) Pub. No.: US 2025/0159718 A1
(43) Pub. Date: May 15, 2025

(54) TRANSMISSION SCHEDULING IN A COMMUNICATION NETWORK

(71) Applicant: Telefonaktiebolaget LM Ericsson (publ), Stockholm (SE)

(72) Inventors: Du Ho KANG, Sollentuna (SE); Jose Luis PRADAS, Stockholm (SE); Richard TANO, Stockholm (SE); Jonathan PALM, Luleå (SE)

(21) Appl. No.: 18/832,783

(22) PCT Filed: Jan. 29, 2023
(86) PCT No.: PCT/SE2023/050076

§ 371 Date: Jul. 24, 2024

Related U.S. Application Data
(60) Provisional application No. 63/304,541, filed on Jan. 28, 2022.

(51) Int. Cl. H04W 72/566; H04W 72/1268

(52) U.S. Cl. CPC H04W 72/569; H04W 72/1268

(57) ABSTRACT

A method performed by a communication device configured for use in a communication network is disclosed. The communication device receives, from a network node in the communication network, signaling indicating, on a transmission grant by transmission grant basis, which one or more prioritization criteria is to govern transmission scheduling by the communication device. The communication device also performs transmission scheduling according to the signaling.

### TECHNICAL FIELD

The present application relates generally to a communication network, and relates more particularly to transmission scheduling in such a network.

### BACKGROUND

A communication device operating in a 5G network may implement a medium access control (MAC) entity which receives data on one or more logical channels from a higher layer. The MAC entity schedules the received data for transmission, e.g., on one or more transport layers offered by the MAC entity to a lower layer. Such scheduling may for instance involve selecting one or more logical channels to which to allocate resources for a transmission, and then allocating resources to the selected logical channel(s), e.g., according to a prioritization of the logical channel(s).

Logical channel prioritization as implemented heretofore involves selection of the data in the different logical channels based on a pre-set priority and in a pre-set bucket size. This results in a simple and predictable method to select data from the different queues, which may be acceptable when for some types of traffic, such as enhanced Mobile Broadband (eMBB) traffic, e.g., bursty traffic with random arrival times which do not have tight timing requirements. Existing approaches prove problematic, though, for other types of traffic, such as for eXtended Reality (XR) traffic, which have inherent timing requirements which need to be met to comply with the agreed quality of service (QOS). Accordingly, existing approach to uplink scheduling proves unsatisfactory, at least for some types of services or traffic.

### SUMMARY

Some embodiments herein give a communication network tools to control which of multiple prioritization methods a communication device should use, e.g., depending on the type of traffic or services. In particular, some embodiments provide mechanisms which indicate to a communication device how to utilize a grant, whether using logical channel prioritization, delay-aware prioritization, or some other prioritization mechanism specified at a later point. The network in some embodiments, for example, configures each logical channel identity (LCID) with zero or more prioritization mechanisms, e.g., via radio resource control (RRC) signaling. The network may then indicate the prioritization mechanism that applies for a given grant, e.g., using a Physical Downlink Control (PDCCH) indication. Depending on the RRC configuration and the PDCCH indication, the medium access control (MAC) at the communication device selects the eligible LCIDs from which data will be taken and to which the indicated prioritization mechanism will apply.

Certain embodiments may provide one or more of the following technical advantage(s). Some embodiments enable the communication network to flexibly tell a communication device which prioritization mechanism to use for a given grant, optimizing the resources for each of the configured services. This may lead to better network resource utilization and may assist to better meet the quality of service (QOS) of different users and services.

Generally, embodiments herein include a method performed by a communication device configured for use in a communication network. The method comprises receiving, from a network node in the communication network, signaling indicating which one or more prioritization criteria is to govern transmission scheduling by the communication device.

In some embodiments, the signaling indicates this on a transmission grant by transmission grant basis.

In some embodiments, the one or more prioritization criteria are respectively associated with one or more prioritization algorithms. In this case, the signaling indicates according to which one or more prioritization algorithms the communication device is to perform transmission scheduling. In one or more of these embodiments, the one or more prioritization algorithms include a logical channel prioritization algorithm and a delay-aware prioritization algorithm.

In some embodiments, the signaling indicates which one or more prioritization criteria is to govern transmission scheduling at a medium access control, MAC, layer or at a MAC entity of the communication device.

In some embodiments, the method further comprises receiving, from the network node, a grant for a transmission. In some embodiments, the signaling indicates which one or more prioritization criteria is to govern scheduling of the transmission for the grant. In one or more of these embodiments, each logical channel or buffer is associated with one or more prioritization criteria. In some embodiments, the method further comprises selecting one or more logical channels or buffers to which to allocate resources for the transmission by selecting one or more logical channels or buffers that are associated with at least one of the one or more prioritization criteria indicated by the signaling. In one or more of these embodiments, the method further comprises determining, for each logical channel or buffer, a prioritization criteria that is associated with that logical channel or buffer. In one or more of these embodiments, the method further comprises selecting one or more logical channels or buffers to which to allocate resources for the transmission by selecting one or more logical channels or buffers that are associated with one of the one or more prioritization criteria indicated by the signaling. In one or more of these embodiments, the signaling indicates one or more thresholds. In some embodiments, said determining is based on the one or more thresholds. In one or more of these embodiments, the one or more thresholds comprise one or more buffer thresholds or one or more packet delay budget left thresholds. In one or more of these embodiments, said determining comprises, for each logical channel or buffer that is able to be associated with multiple prioritization criteria, selecting one of the multiple prioritization criteria to associate with the logical channel or buffer, based on the one or more thresholds.

In some embodiments, the signaling indicates a priority ordering of the one or more prioritization criteria. In one or more of these embodiments, each logical channel or buffer is associated with one or more prioritization criteria. In some embodiments, the method further comprises receiving, from the network node, a grant for a transmission. In some embodiments, the method further comprises allocating resources to the one or more logical channels or buffers for the transmission, in descending priority order according to the priority ordering indicated by the signaling. In some embodiments, resources are allocated to any logical channel or buffer associated with a prioritization criteria that has a higher priority before resources are allocated to any logical channel or buffer associated with a prioritization criteria that has a lower priority.

In some embodiments, the method further comprises receiving, from the network node, signaling indicating, for each of one or more logical channels or buffers, one or more prioritization criteria associated with that logical channel or buffer. The method further comprises receiving, from the network node, a grant for a transmission. In some embodiments, the signaling indicates which one or more prioritization criteria is to govern scheduling of the transmission for the grant. The method further comprises for any logical channel or buffer for which the received signaling does not indicate one or more prioritization criteria associated with that logical channel or buffer, associating the logical channel or buffer with the one or more prioritization criteria that is to govern scheduling of the transmission for the grant.

In some embodiments, the signaling comprises physical layer signaling.

In some embodiments, the signaling comprises an indication on a Physical Downlink Control Channel, PDCCH.

In some embodiments, the signaling indicates which one or more prioritization criteria is to govern transmission scheduling by the communication device by indicating which one or more prioritization criteria is to govern selection of one or more logical channels to which to allocate transmission resources. Additionally or alternatively, the signaling indicates which one or more prioritization criteria is to govern transmission scheduling by the communication device by indicating which one or more prioritization criteria is to govern allocation of resources across one or more selected logical channels.

In some embodiments, the signaling indicates which one or more prioritization criteria is to govern transmission scheduling by the communication device by indicating which one or more prioritization criteria is to govern selection of one or more buffers to which to allocate transmission resources. Additionally or alternatively, the signaling indicates which one or more prioritization criteria is to govern transmission scheduling by the communication device by indicating which one or more prioritization criteria is to govern allocation of resources across one or more selected buffers.

In some embodiments, the method further comprises receiving, from the network node, signaling indicating, for each of one or more logical channels or buffers, one or more prioritization criteria associated with that logical channel or buffer. In one or more of these embodiments, the signaling is radio resource control, RRC, signaling.

In some embodiments, the method further comprises performing transmission scheduling based on the one or more prioritization criteria.

In some embodiments, the method further comprises performing scheduling of the transmission based on the one or more prioritization criteria.

Other embodiments herein include a method performed by a communication device configured for use in a communication network. The method comprises receiving, from a network node in the communication network, signaling that indicates, for each of one or more logical channels or buffers, one or more prioritization criteria associated with that logical channel or buffer.

In some embodiments, the signaling indicates this on a transmission grant by transmission grant basis.

In some embodiments, the signaling is radio resource control, RRC, signaling.

In some embodiments, the method further comprises performing transmission scheduling based on the signaling.

In some embodiments, the method further comprises providing user data and forwarding the user data to a host computer via the transmission to a base station.

Other embodiments herein include a method performed by a network node configured for use in a communication network. The method comprises transmitting, to a communication device, signaling indicating which one or more prioritization criteria is to govern transmission scheduling by the communication device.

In some embodiments, the signaling indicates this on a transmission grant by transmission grant basis.

In some embodiments, the one or more prioritization criteria are respectively associated with one or more prioritization algorithms. In this case, the signaling indicates according to which one or more prioritization algorithms the communication device is to perform transmission scheduling. In one or more of these embodiments, the one or more prioritization algorithms include a logical channel prioritization algorithm and a delay-aware prioritization algorithm.

In some embodiments, the signaling indicates which one or more prioritization criteria is to govern transmission scheduling at a medium access control, MAC, layer or at a MAC entity of the communication device.

In some embodiments, the method further comprises transmitting, to the communication device, a grant for a transmission. In this case, the signaling indicates which one or more prioritization criteria is to govern scheduling of the transmission for the grant. In one or more of these embodiments, each logical channel or buffer is associated with one or more prioritization criteria. In one or more of these embodiments, the signaling indicates one or more thresholds based on which the communication device is to determine a prioritization criteria that is to be associated with each logical channel or buffer. In one or more of these embodiments, the one or more thresholds comprise one or more buffer thresholds or one or more packet delay budget left thresholds.

In some embodiments, the signaling indicates a priority ordering of the one or more prioritization criteria.

In some embodiments, the signaling comprises physical layer signaling.

In some embodiments, the signaling comprises an indication on a Physical Downlink Control Channel, PDCCH.

In some embodiments, the signaling indicates which one or more prioritization criteria is to govern transmission scheduling by the communication device by indicating which one or more prioritization criteria is to govern selection of one or more logical channels to which to allocate transmission resources. Additionally or alternatively, the signaling indicates which one or more prioritization criteria is to govern transmission scheduling by the communication device by indicating which one or more prioritization criteria is to govern allocation of resources across one or more selected logical channels.

In some embodiments, the signaling indicates which one or more prioritization criteria is to govern transmission scheduling by the communication device by indicating which one or more prioritization criteria is to govern selection of one or more buffers to which to allocate transmission resources. Additionally or alternatively, the signaling indicates which one or more prioritization criteria is to govern transmission scheduling by the communication device by indicating which one or more prioritization criteria is to govern allocation of resources across one or more selected buffers.

In some embodiments, the method further comprises transmitting, to the communication device, signaling indicating, for each of one or more logical channels or buffers, one or more prioritization criteria associated with that logical channel or buffer. In one or more of these embodiments, the signaling is radio resource control, RRC, signaling.

Other embodiments herein include a method performed by a network node configured for use in a communication network. The method comprises transmitting, to a communication device, signaling that indicates, for each of one or more logical channels or buffers, one or more prioritization criteria associated with that logical channel or buffer.

In some embodiments, the signaling is radio resource control, RRC, signaling.

Embodiments herein also include corresponding apparatus, computer programs, and carriers of those computer programs.

### BRIEF DESCRIPTION OF THE DRAWINGS

FIG. 1 is a block diagram of a communication device and a communication network according to some embodiments.

FIG. 2A is a block diagram of an example of buffers for logical channels according to some embodiments.

FIG. 2B is a block diagram of an example legacy grant based on logical channel prioritization according to some embodiments.

FIG. 2C is a block diagram of an example grant based on delay-aware prioritization according to some embodiments.

FIG. 3A is a block diagram of buffers of two logical channels with virtual buffers for packets with different packet delay budgets remaining according to some embodiments.

FIG. 3B is a logic flow diagram of delay-aware scheduling according to some embodiments with LCIDs configured.

FIG. 4A is a block diagram of three buffers for packets with different packet delay budgets remaining according to other embodiments.

FIG. 4B is a logic flow diagram of delay-aware scheduling according to some embodiments without LCIDs configured.

FIG. 5 is a line chart of an example of frame latency measured over the radio access network (RAN) according to some embodiments.

FIG. 6 is a line chart of an example of the cumulative distribution functions of the number of transport blocks required to deliver a video frame according to some embodiments.

FIG. 7 is a block chart of an example of the traffic arrival times of different services according to some embodiments.

FIG. 8 is a logic flow diagram of a method performed by a communication device according to some embodiments.

FIG. 9 is a logic flow diagram of a method performed by a communication device according to other embodiments.

FIG. 10 is a logic flow diagram of a method performed by a network node according to some embodiments.

FIG. 11 is a block diagram of a communication device according to some embodiments.

FIG. 12 is a block diagram of a network node according to some embodiments.

FIG. 13 is a block diagram of a communication system in accordance with some embodiments

FIG. 14 is a block diagram of a user equipment according to some embodiments.

FIG. 15 is a block diagram of a network node according to some embodiments.

FIG. 16 is a block diagram of a host according to some embodiments.

FIG. 17 is a block diagram of a virtualization environment according to some embodiments.

FIG. 18 is a block diagram of a host communicating via a network node with a UE over a partially wireless connection in accordance with some embodiments.

### DETAILED DESCRIPTION

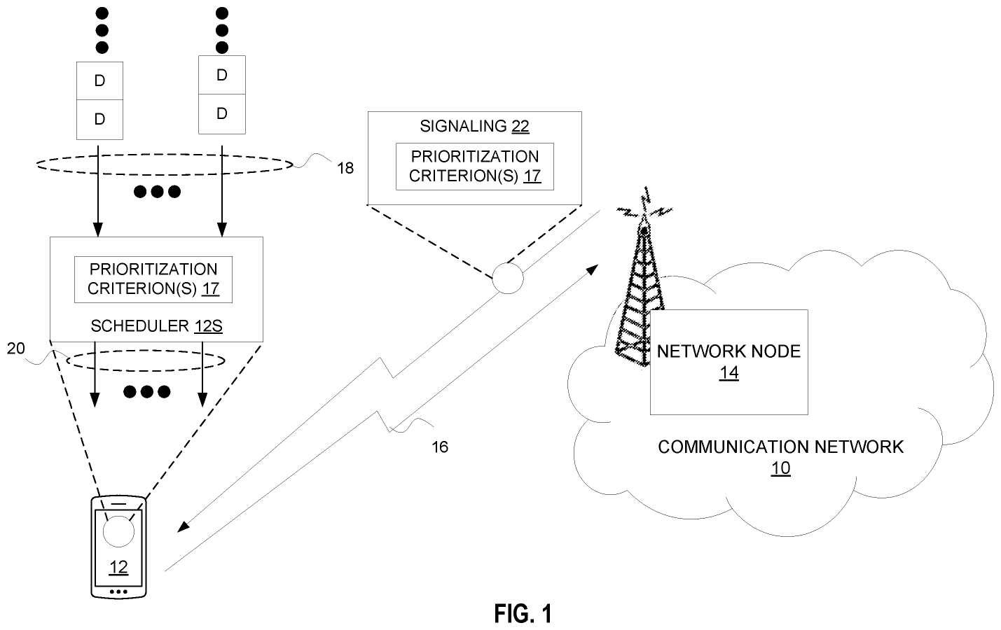

FIG. 1 shows a communication network 10 according to some embodiments. The communication network 10 provides communication service to a communication device 12. In some embodiments, the communication network 10 is a wireless communication network, in which case the communication device 12 communicates with the communication network 10 over a wireless interface 16.

As shown, the communication device 12 receives data units D on logical channels 18. These data units D may for instance be received by a scheduler 12S as shown. In these and other embodiments, the communication device 12 receives data units D on logical channels 18 at a medium access control (MAC) layer of the communication device 12 or at a MAC entity of the communication device 12. In this case, the data units D may be MAC service data units (SDUs).

The communication device 12 schedules the data units D for transmission, e.g., to the communication network 10. Such may involve for instance scheduling the data units D for transmission on one or more transport channels 20 to a lower layer, e.g., which may control transmission on the wireless interface 16 to the communication network. The data units D in these and other embodiments may be segmented and/or aggregated for transmission in data blocks, e.g., on the one or more transport channels 20. Regardless, in some embodiments, scheduling the data units D for transmission involves selecting which logical channels 18 to allocate transmission resources and allocating transmission resources to the selected logical channels 18. Here, transmission resources may for instance correspond to available spaces in a data block to be transmitted during a transmission time interval (TTI) at the communication device 12.

In this context, according to some embodiments herein, the communication device 12 schedules the data units D for transmission based on one or more prioritization criterions 17. The prioritization criterion(s) 17 thereby govern transmission scheduling by the communication device 12. Notably, according to embodiments herein, the prioritization criterion(s) 17 which govern transmission scheduling are configurable. As shown in FIG. 1, then, the communication device 12 may receive, from a network node 14, signaling 22 indicating which one or more prioritization criteria 17 is to govern transmission scheduling by the communication device 12. In fact, in some embodiments, the signaling 22 indicates this on a transmission grant by transmission grant basis, e.g., so as to indicate, for each transmission grant, which one or more prioritization criteria 17 is to govern scheduling of transmission(s) for that grant. The signaling 22 in these and other embodiments may be physical layer signaling or other lower layer signaling (e.g., medium access control, MAC, signaling) that allows such dynamic signaling on a grant by grant basis.

In some embodiments, for example, the one or more prioritization criteria 17 are respectively associated with one or more prioritization algorithms. In this case, the signaling 22 may indicate according to which one or more prioritization algorithms the communication device 12 is to perform transmission scheduling.

In one embodiment, for example, the one or more prioritization algorithms include a logical channel prioritization algorithm and a delay-aware prioritization algorithm. In this case, the prioritization criterion(s) 17 associated with the logical channel prioritization algorithm may include a priority of the logical channels 18, e.g., such that resources are scheduled for logical channels 18 in order of decreasing priority of the logical channels 18. By contrast, the prioritization criterion(s) 17 associated with the delay-aware prioritization algorithm may include timing information T for the data units D to be transmitted. In some embodiments, for example, the timing information T includes, for each data unit D, a time budget remaining (TBR) for the data unit D to meet a timing requirement. For example, where the data units D are packets, the timing requirement for a packet may be a packet delay budget. In this case, the time budget remaining for a packet may comprise an amount of time left before the packet must be delivered to a reference point in order to meet the packet delay budget for the packet.

More particularly with regard to the delay-aware prioritization algorithm, in some embodiments, the communication device 12 associates each data unit D with a priority P1, P2, P3, . . . . The communication device 12 may do so based on the time budget remaining (TBR) for the data unit D. Here, then, the TBR for each data unit D constitutes the timing information T. In some embodiments, a data unit D is associated with a higher priority the smaller the time budget remaining for the data unit D. In one embodiment, for example, the communication device 12 associates each data unit D with one of multiple possible priorities P1, P2, P3 based on within which one of multiple time budget remaining ranges the time budget remaining for the data unit D belongs, e.g., with data units D associated with priority P1 having relatively small time budgets remaining, data units associated with priority P2 having moderate time budgets remaining, and data units D associated with priority P3 having relatively larger time budgets remaining. The communication device 12 may then schedule the data units D for transmission based on the priority order of the logical channels and based on the priorities P1, P2, P3 . . . associated with the data units D. For example, in some embodiments, the communication device 12 allocates transmission resources to the logical channels 18 in a decreasing priority order, with transmission resources being allocated for transmission of all data units D associated with a higher priority before transmission resources are allocated for transmission of any data units D associated with a lower priority.

For example, where P1 is higher in priority than P2 and P2 is higher in priority than P3, the communication device 12 allocates transmission resources for all of the data units D associated with priority P1 before transmission resources are allocated for transmission of any data units D associated with priority P2 or P3. Similarly, the communication device 12 allocates transmission resources for all of the data units D associated with priority P2 before transmission resources are allocated for transmission of any data units D associated with priority P3.

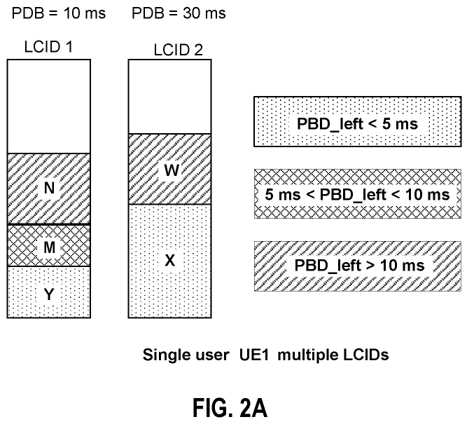

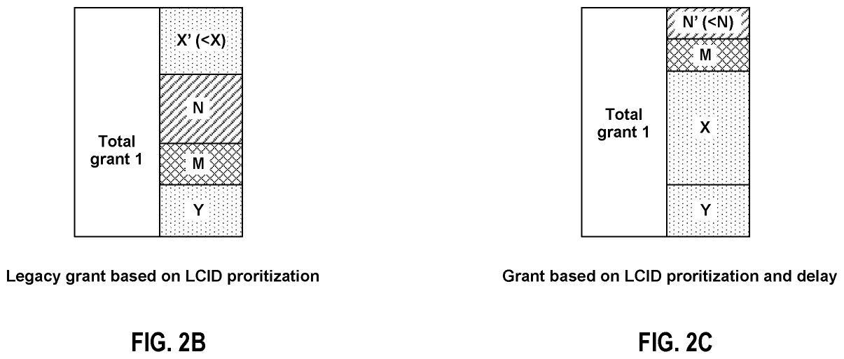

Consider an example shown in FIGS. 2A-2C where the communication device 12 is exemplified as a user equipment (UE) in a 5G network, a data unit D is exemplified as a packet, a logical channel 18 is exemplified as being identified by a logical channel ID (LCID), and timing information T is exemplified as packet delay budget left (PDB_left). FIG. 2A shows buffers of a UE with 2 logical channel identities (LCIDs). Assume LCID 1 and LCID 2 have received application-layer data units (ADUs) from an extended Reality (XR) application, e.g., video and pose with different packet delay budgets (PDBs). Due to the different traffic characteristics of each flow, and the different arrival and/or grant times, there is a different amount of remaining bits (X, Y, M,N, W) in each of the buffers. In addition, at a given LCID, each of the remaining bits also has a different amount of remaining PDB, noted as PDB_left. Each shading corresponds to a different PDB_left (in general, it could be any timing information about the packet and its relation towards the timing requirements).

FIG. 2B shows scheduling according to a legacy approach that is based on LCID prioritization. This legacy approach to logical channel prioritization does not take into account the time packets have been queued and/or whether certain packets have timing requirements to meet. Indeed, in this legacy approach, the UE process to select the LCIDs from which data will be taken from their buffer does not consider delay. As applied to this example, LCID1 is the highest priority LCID and, thus, bits of Y, M, and N will be taken before data from LCID2. As shown in FIG. 2B, then, this leads to only part of X bits (X′<X) being taken from the buffer of LCID2 for the grant. However, X bits should have been prioritized over M and N if PDB_left had been considered.

Accordingly, this legacy scheduling method is sub-optimal if the traffic has inherent timing requirements which need to be met to comply with the agreed quality of service (QOS). Some types of traffic also have the characteristic to be compounded by multiple flows with distinct timing requirements and each flow may have a different average packet size. These additional factors complicate a configuration based only on the priority of the logical channel, the prioritized bit rate (PRB), and the bucket-side duration (BSD).

The network heretofore does not know the PDB_left for the data in each of the LCIDs or logical channel group (LCG) since a user equipment (UE) heretofore provides a buffer status report (BSR) based on buffered data in each LCG. In some embodiments herein, then, the UE provides a delay-aware BSR so as to provide the network with timing information of the queued packets. This allows the network to provide a grant size which may take into account the timing information indicated by the UE. Yet, even if the network provides the correct grant, some embodiments herein enable the UE to apply a logical channel prioritization procedure to make use of the grant adequately.

FIG. 2C by contrast shows the grant resulting from delay-aware scheduling according to some embodiments herein. As shown in FIG. 2C, the UE first allocates resources for transmission of Y, and then allocate resources for transmission of X, before allocating any resources for transmission of M or N. After allocating resources for transmission of X, the UE allocates resources for transmission of M. After allocating resources for transmission of M, the UE allocates resources for transmission of N. In this way, the UE allocates resources for only part of N, rather than only part of X as in FIG. 2B.

Consider now additional details of a delay-aware prioritization algorithm according to some embodiments, as exemplified with various solutions for delay-aware prioritization, in the following context where the communication network 10 is exemplified as a 5G network, with the communication device 12 being exemplified as a UE, a data unit D exemplified as a packet, and a logical channel 18 exemplified as being identified by a logical channel ID (LCID).

In one delay-aware prioritization embodiment, for each packet the UE buffers, the UE associates a time flag which will be checked later against the latency requirements of the given packet. If LCIDs are configured, then a packet is queued in the buffer associated to a given LCID. Within the given LCID, the UE may have a number of ‘virtual buffers’ each of them defined by a minimum and maximum time thresholds.

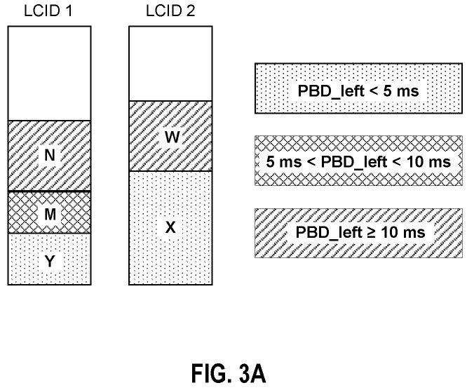

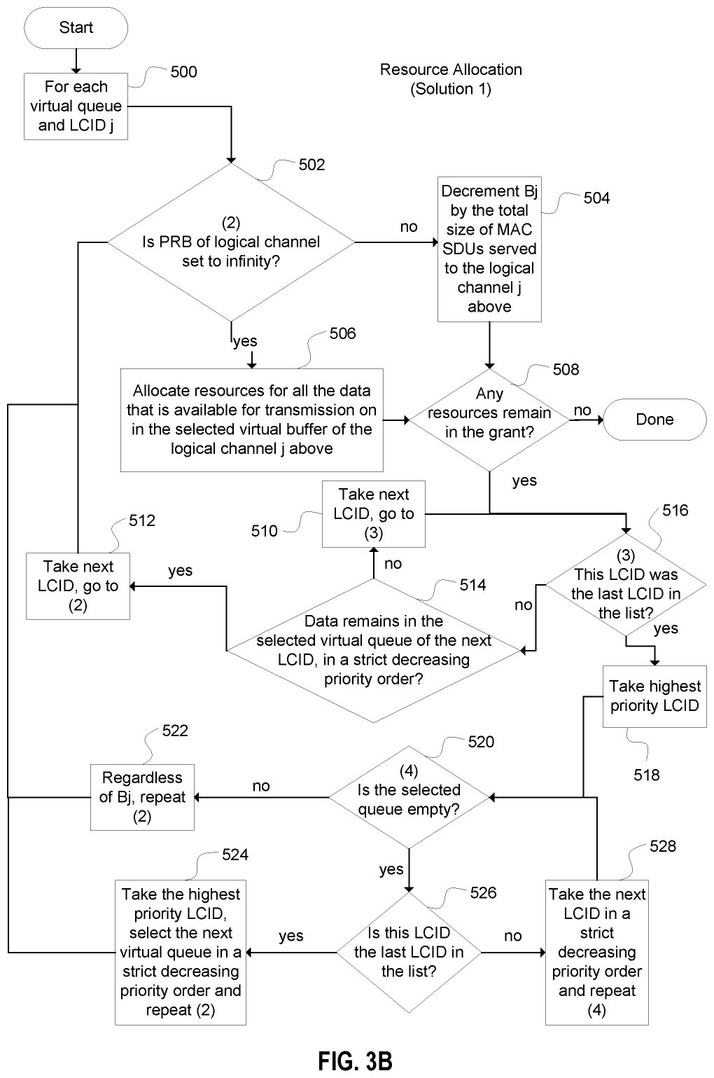

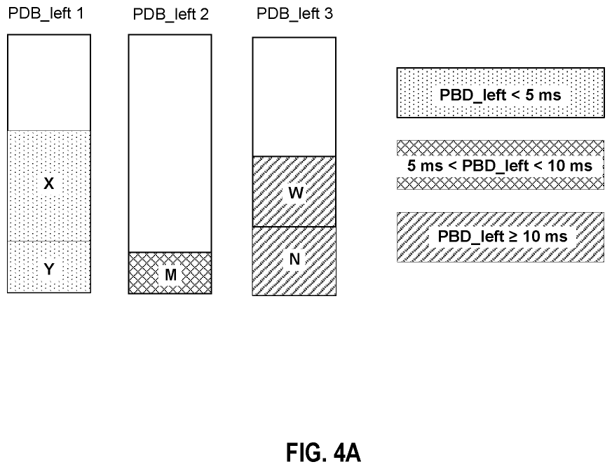

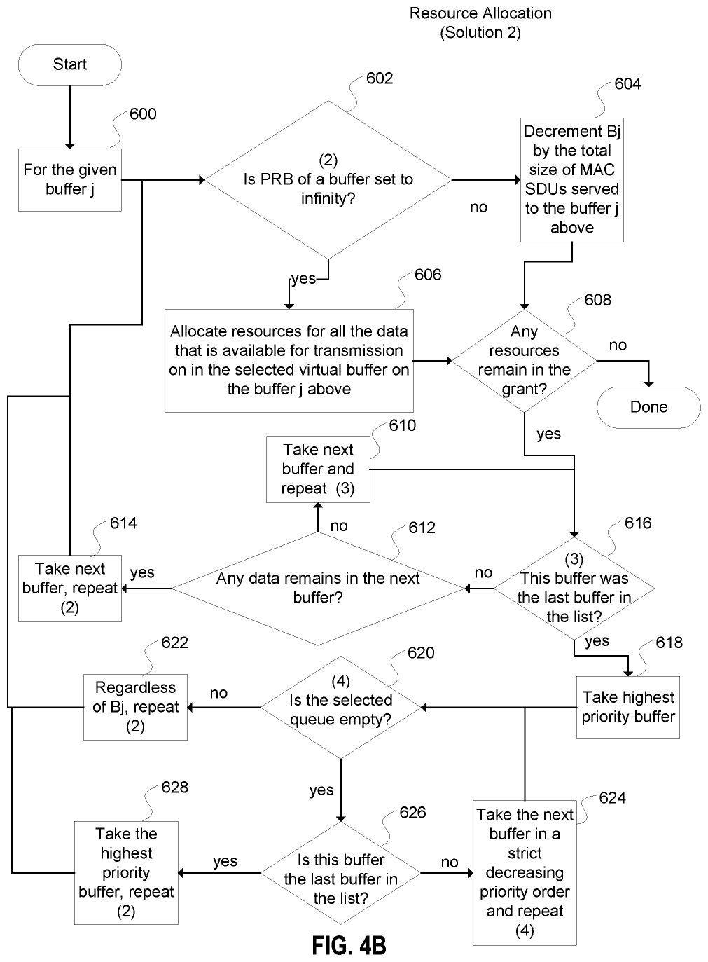

FIG. 3A shows two LCIDs; in each of them there are 3 virtual buffers. In one virtual buffer, all packets in a given LCID with a PDB_left of equal to or less than 5 ms will be queued. A second virtual buffer will contain all packets in a given LCID with a PDB_left larger than 5 ms and equal to or less than 10 ms. The third virtual buffer will queue all packets in a given LCID with PDB_left larger than 10 ms. The number of virtual buffers and the thresholds are configured by the network. Packets within a LCID will be moved by the UE from one virtual queue to another depending on the PDB_left for the given packet.

### Solution 1: (LCIDs Configured)

If the UE has been configured by the signaling 22 to use delay-aware scheduling for a grant, the UE selects the LCIDs, if they are configured, and allocates resources as shown in FIG. 3B and as follows.

The selection of a logical channel is based on the fulfillment of all the following conditions: (i) same conditions as legacy; and (ii) if the transmission timing indicated in the associated grant is feasible for any value of PDB_left in the corresponding LCID, e.g., remaining time for transmission or successful reception of corresponding PUSCH is less than of any values of PDB_left (this can be configured by a new IE).

Above, new iEs can be controlled by RRC for introducing additional mapping restrictions for each logical channel for delay-aware scheduling. And the grant type of delay-aware scheduling and information for grant timing are included in uplink transmission information received from lower layers for the corresponding scheduled uplink transmission.

More particularly, as shown in FIG. 3B, the allocation of the resources is performed as follows.

The selected logical channels for the UL grant with Bj>0 are allocated resources in a decreasing priority order. The highest priority LCID is served first. If multiple LCIDs have similar priority, the UE selects the LCID that has the least bits in the highest priority virtual queue. Logical channels are served until there is no data in all (virtual) buffers or the UL grant is exhausted. The highest priority virtual queue is selected first for all LCIDs. Logical channels configured with equal priority should be served equally.

For the given virtual queue and LCID j (Block 500), (2) If PRB of a logical channel is not set to infinity (NO at Block 502), decrement Bj by the total size of MAC SDUs served to the logical channel j above (Block 504). Else, (YES at Block 502), allocate resources for all the data that is available for transmission on in the selected virtual buffer of the logical channel j above (Block 506).

If any resources remain in the grant (YES at Block 508), the UE performs the following. (3) If this LCID was not the last LCID in the list (NO at Block 516), and data remains in the selected virtual queue of the next LCID (in a strict decreasing priority order) (YES at Block 514), the UE takes the next LCID and repeats (2) (Block 512). Else, if this LCID was not the last LCID in the list (YES at Block 516), but no data remains in the selected virtual queue of the next LCID (in a strict decreasing priority order) (NO at Block 514), the UE takes the next LCID and repeat (3) (Block 510).

Else, if this LCID was the last LCID in the list (YES at Block 516), the UE takes the highest priority LCID (Block 518). (4) If the selected virtual queue is not empty (NO at Block 520), regardless of Bj, the UE repeats (2). Else, if the selected virtual queue is empty (YES at Block 520), and this LCID was not the last LCID in the list (NO at Bock 526), the UE takes the next LCID in a strict decreasing priority order and repeats (4) (Block 528). Else, if the selected virtual queue is empty (YES at Block 520), but this LCID was the last LCID in the list (YES at Bock 526), the UE takes the highest priority LCID, selects the next virtual queue in a strict decreasing priority order, and repeats (2) (Block 524).

Bj is a variable used and maintained for logical channel j. A variable is maintained for each logical channel. Thus, PRB and BSD is provided for each logical channel (as in legacy).

Alternatively, Bi,j is used and maintained for each virtual buffer in each LCID, where i represents the virtual buffer and j the logical channel. In this latter case, PRB and BSD could be identical for each virtual buffer in each LCID. Another option is that PRB and/or BSD is provided for each virtual buffer in each LCID. This allows for finer differentiation between virtual buffer in one logical channel and also among logical channels.

In these embodiments where Bi,j is used, Bi,j is initialized to zero when the logical channel is established. For each logical channel, Bi,j is incremented by the product (PBRi,j×T) before every instance of the LCP procedure, where T is the time elapsed since Bi,j was last incremented. if the value of Bi,j is greater than the bucket size (i.e. PBRi,j×BSDi,j), the UE sets Bi,j to the bucket size.

### Solution 2: (No LCIDs Configured)

In other embodiments for delay-aware scheduling, LCIDs are not configured. If LCIDs are not configured, then a packet is queued in a buffer defined by minimum and maximum time thresholds. FIG. 3A shows 3 buffers. In one buffer, all packets with a PDB_left of equal to or less than 5 ms will be queued. A second buffer will contain all packets with a PDB_left larger than 5 ms and equal to or less than 10 ms. The third buffer will queue all packets with PDB_left larger than 10 ms. The number of buffers and the thresholds are configured by the network. Packets will be moved by the UE from one buffer to another depending on the PDB_left for the given packet.

If the UE has been configured to use delay-aware scheduling and LCIDs have not been configured, when the UE has a grant, the UE allocates resources as shown in FIG. 3B and as follows.

The selection of the buffers is based on the fulfillment of all the following conditions: (i) same conditions as legacy but restricted for each buffer with a different PDB_left; and (ii) if the transmission timing indicated in the associated grant is feasible for any value of PDB_left in the corresponding buffer, e.g., remaining time for transmission or successful reception of corresponding PUSCH is less than of any values of PDB_left. This can be configured by a new IE. Above, new iEs can be controlled by RRC for introducing additional mapping restrictions for each buffer for delay-aware scheduling, and the grant type of delay-aware scheduling and information for grant timing are included in uplink transmission information received from lower layers for the corresponding scheduled uplink transmission.

The allocation of the resources is performed as follows. The selected buffers for the UL grant with Bj>0 are allocated resources in a decreasing priority order. The highest priority buffer is served first. Buffers are served until there is no data in all buffers or the UL grant is exhausted. Buffers configured with equal priority should be served equally.

For the given buffer j (Block 600), (2) if the PRB of a buffer is not set to infinity (NO at Block 602), the UE decrements Bj by the total size of MAC SDUs served to the buffer j above (Block 604). Else (YES at Block 606), the UE allocates resources for all the data that is available for transmission on the buffer j above (Block 606).

If any resources remain (YES at Block 608), the UE performs the following. (3) If this buffer was not the last buffer in the list (NO at Block 616), and if data remains in the next buffer (in a strict decreasing priority order) (YES at Block 612), the UE takes the next buffer and repeats (2) (Block 614). Else, if this buffer was not the last buffer in the list (NO at Block 616), but no data remains in the next buffer (in a strict decreasing priority order) (NO at Block 612), the UE takes the next buffer and repeats (3) (Block 610).

Else, if this buffer was the last buffer in the list (YES at Block 616), the UE takes the highest priority buffer (Block 618). (4) If the selected buffer is not empty (NO at Block 622), the UE, regardless of Bj, repeats (2) (Block 622). Else, if the selected buffer is empty (YES at Block 622), and if this buffer was not the last buffer in the list (NO at Block 626), the UE takes the next buffer in a strict decreasing priority order and repeats (4) (Block 624). Otherwise, if the selected buffer is empty (YES at Block 622), but this buffer was the last buffer in the list (YES at Block 626), the UE takes the highest priority buffer and repeats (2) (Block 628).

Bj is a variable used and maintained for each buffer. Thus, PRB and BSD is provided for each buffer.

Bj is initialized to zero when the buffer is established. For each buffer, Bj is incremented by the product (PBRj×T) before every instance of the LCP procedure, where T is the time elapsed since Bj was last incremented. If the value of Bj is greater than the bucket size (i.e. PBRj×BSDj), the UE sets Bj to the bucket size.

Solution 3: (LCIDs Configured with Single PDB_Left)

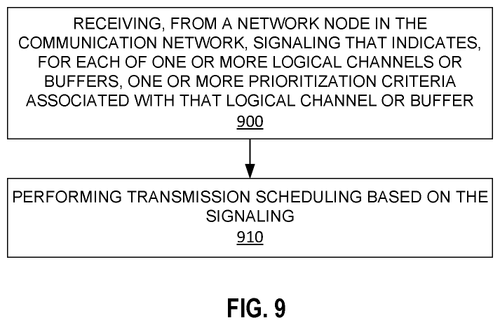

In another solution for delay-aware scheduling, each LCID is configured with a single PDB_left value whose mapping is controlled by RRC and the traditional LCID prioritization procedure is applied based on legacy conditions or legacy and new iEs for delay-aware scheduling. See FIG. 9. In this case, a virtual buffer is not needed. A different LCID is defined based on the PDB_left value. Higher priority LCID is assigned with shorter PDB_left value. The allocation of resource is also followed as a legacy method.

Some embodiments herein are applicable in the following context where the communication network 10 is exemplified as a 5G network.

5G is the fifth generation of mobile communications, addressing a wide range of use cases from enhanced mobile broadband (eMBB) to ultra-reliable low-latency communications (URLLC) to massive machine type communications (mMTC). 5G includes the New Radio (NR) access stratum interface and the 5G Core Network (5GC). The NR physical and higher layers are reusing parts of the Long Term Evolution (LTE) specification, and to that adds needed components when motivated by new use cases.

Low-latency high-rate applications such as extended Reality (XR) and cloud gaming are important in the 5G era. XR may refer to all real-and-virtual combined environments and human-machine interactions generated by computer technology and wearables. It is an umbrella term for different types of realities including Virtual reality (VR), Augmented reality (AR), Mixed reality (MR), and the areas interpolated among them. The levels of virtuality range from partially sensory inputs to fully immersive VR.

5G NR is designed to support applications demanding high rate and low latency in line with the requirements posed by the support of XR and cloud gaming applications in NR networks.

### Low-Latency High-Rate XR Applications

The low-latency applications like XR and cloud gaming require bounded latency, not necessarily ultra-low latency. The end-to-end latency budget may be in the range of 20-80 ms, which needs to be distributed over several components including application processing latency, transport latency, radio link latency, etc. For these applications, short transmission time intervals (TTIs) or mini-slots targeting ultra-low latency may not be effective.

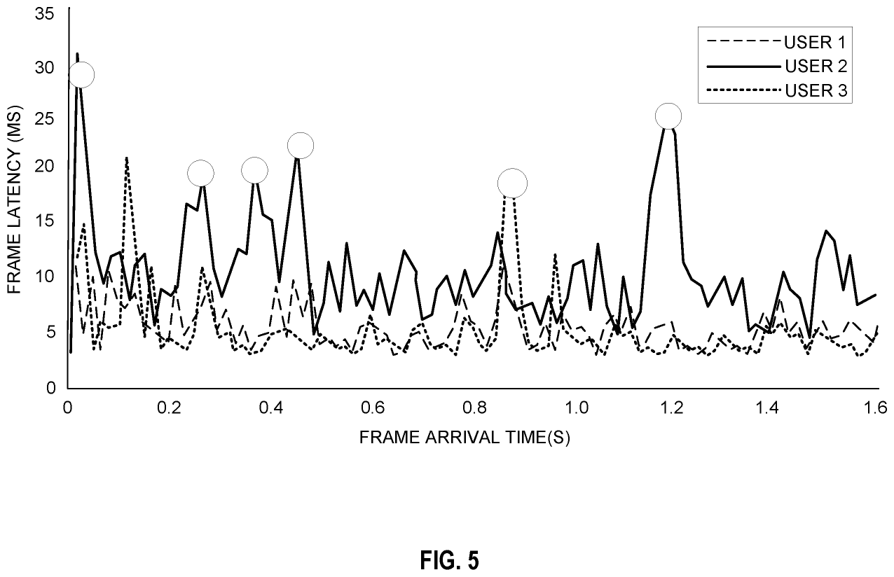

FIG. 5 shows an example of frame latency measured over a radio access network (RAN), excluding application and core network latencies. It can be seen that there exist frame latency spikes in the RAN. The sources for the latency spikes may include queuing delay, time-varying radio environments, and time-varying frame sizes, among others. Tools that can help to remove latency spikes are beneficial to enable better 5G support for this type of traffic.

In addition to bounded latency requirements, applications like XR and cloud gaming also require high rate transmission. This can be seen from the large frame sizes originated from this type of traffic. The typical frame sizes may range from tens of kilobytes to hundreds of kilobytes. The frame arrival rates may be 60 or 120 frames per second (fps). As a concrete example, a frame size of 100 kilobytes and a frame arrival rate of 120 fps can lead to a rate requirement of 95.8 Mbps.

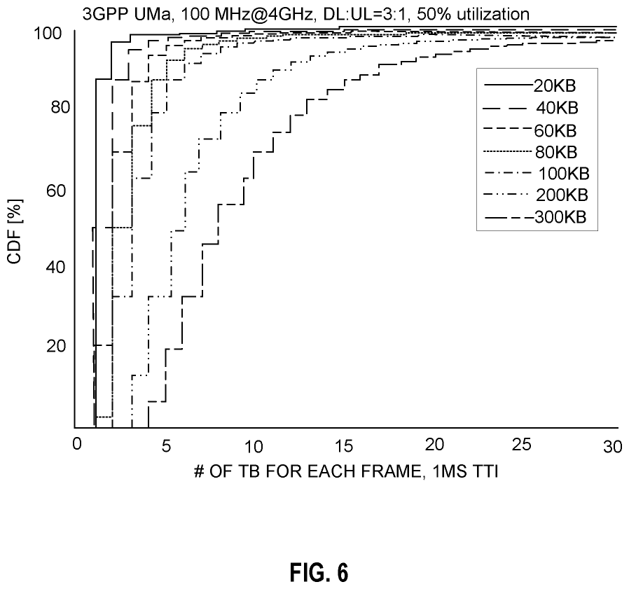

A large video frame is usually fragmented into smaller Internet Protocol (IP) packets and transmitted as several transport blocks (TBs) over several transmission time intervals (TTIs) in the RAN. FIG. 6 shows an example of the cumulative distribution functions of the number of transport blocks required to deliver a video frame with size ranging from 20 KB to 300 KB. For example, FIG. 6 shows that for delivering the frames with a size of 200 KB each, the median number of needed TBs is 5.

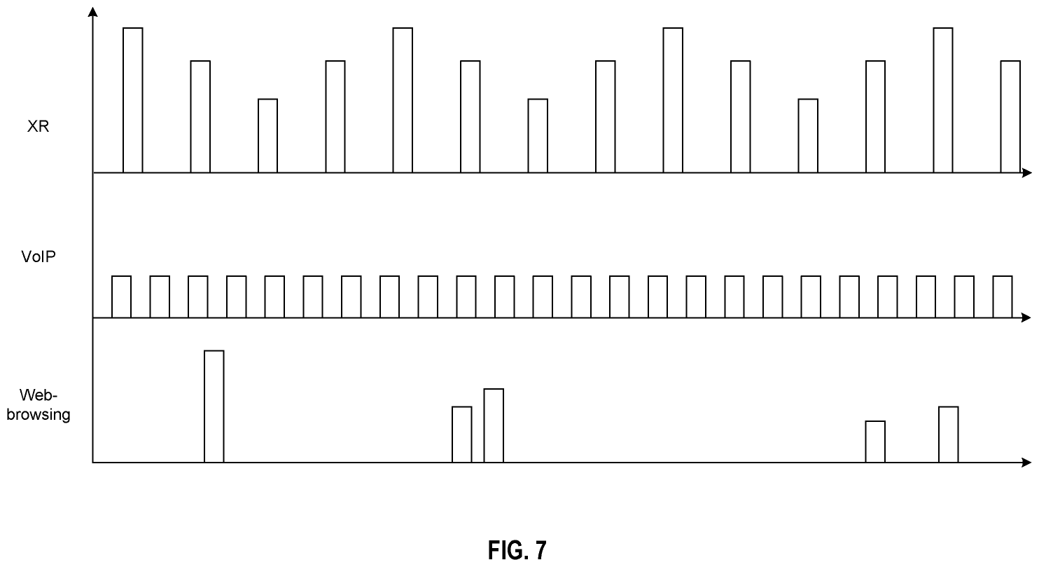

The characteristics of XR traffic arrival are quite distinct from typical web-browsing and Voice over IP (VOIP) traffic as shown in FIG. 7. It is well expected that the arrival time is quasi-periodic and largely predictable as VoIP. However, its data size is orders of magnitude larger than VoIP, as discussed above. In addition, similar to web-browsing, the data size is different at every application Protocol Data Unit (PDU) arrival instance due to dynamics of contents and human motion.

### Scheduling and Logical Channel Prioritization

When the network provides an uplink (UL) grant to the UE, the UE in some embodiments is configurable by the signaling 22 to perform what is called “logical channel prioritization”, as one of the possible prioritization algorithms associated with the prioritization criterion(s) 17 as described above. The UE may perform logical channel prioritization to decide which Logical Channel IDs (LCID) qualify to transmit data given the current grant, and the amount of data to transmit from each of the selected LCIDs. This process as implemented heretofore is explained in 3GPP TS 38.321 v16.7.0 section 5.4.3 and this section provides a simplified version of the full procedure. The procedure is divided into 2 parts: the selection of the logical channels, and the allocation of resources.

The selection of a logical channel is heretofore based on the fulfillment of all the following conditions: (i) the subcarrier spacing associated to the UL grant is listed in the Information Element (IE) ‘allowedSCS-List’ if this IE was configured; (ii) the Physical Uplink Shared Channel (PUSCH) transmission duration associated to the UL grant is shorter than or equal to the value indicated in ‘maxPUSCH-Duration’, if this IE was configured; (iii) configuredGrantType1Allowed, if configured, is set to true in case the UL grant is a Configured Grant Type 1; (iv) the cell information associated to the UL grant is listed in the IE ‘allowedServingCells’, if configured; (v) allowedCG-List, if configured, includes the configured grant index associated to the UL grant; and (vi) allowedPHY-PriorityIndex, if configured, includes the priority index (as specified in clause 9 of TS 38.213 v16.8.0) associated to the dynamic UL grant.

The allocation of the resources i″ heretofore performed as follows. For the selected logical channels for the UL grant with Bj>0 are allocated resources in a decreasing priority order. If the PBR of a logical channel is set to infinity, the MAC entity shall allocate resources for all the data that is available for transmission on the logical channel before meeting the PBR of the lower priority logical channel(s). Bj is decremented by the total size of MAC SDUs served to logical channel j above. if any resources remain, all the selected logical channels are served in a strict decreasing priority order (regardless of the value of Bj) until either the data for that logical channel or the UL grant is exhausted, whichever comes first. Logical channels configured with equal priority should be served equally.

Bj is a variable used and maintained for each logical channel. ‘j’ is an index associated to one Logical Channel Identity. Bj is initialized to zero when the logical channel is established. For each logical channel, Bj is incremented by the product (PBR×T) before every instance of the LCP procedure, where T is the time elapsed since Bj was last incremented. If the value of Bj is greater than the bucket size (i.e. PBR×BSD), Bj is set to the bucket size.

The priority of each of the configured logical channels is provided by Radio Resource Control (RRC). Among others, the iEs ‘priority’, Prioritized Bit Rate (PBR), and Bucket Size Duration (BSD) are indicated. The IE ‘priority’ provides the priority of a logical channel so that a larger value results a lower priority. This results in that value 1 indicates the highest priority.

According to this logical channel prioritization procedure, the selection of the data in the different logical channels is based on a pre-set priority and in a pre-set bucket size. This results in a simple and predictable method to select data from the different queues at the UE. This mechanism may be acceptable when the UEs are running enhanced Mobile Broadband (eMBB)-type of traffic i.e., bursty traffic with random arrival times which do not have tight timing requirements.

The logical channel prioritization procedure may be sub-optimal for other types of traffic, such as XR traffic since XR traffic has inherent timing requirements which need to be met to comply with the agreed quality of service (Qos). Indeed, the logical channel prioritization does not take into account that time packets have been queued and/or whether certain packets have timing requirements to meet. XR traffic also has the characteristic to be compounded by multiple flows with distinct timing requirements and each flow may have a different average packet size. These additional factors complicate a configuration based only on the priority of the logical channel, the PRB, and the BSD.

Some embodiments herein supplement this logical channel prioritization procedure with a delay-aware prioritization procedure, such that which procedure the UE applies is configurable, e.g., on a grant by grant basis. In this case, then, the signaling 22 herein may indicate, on a grant by grant basis, whether the UE is to apply the logical channel prioritization procedure or the delay-aware prioritization procedure for that grant.

For example, some embodiments exploit a delay-aware buffer status report (BSR) format and triggering mechanisms. When the network gets a delay-aware BSR, the network may allocate the resources considering the information received in the new BSR. When the grant is received by the UE, a delay-aware prioritization procedure may be applied by the UE, instead of the logic channel prioritization procedure, if configured by the network by signaling 22.

Some embodiments thereby give the network tools to control which of the two prioritization methods the UE should use, e.g., depending on the type of traffic or services.

In particular, some embodiments provide mechanisms which indicate to the UE how to utilize a grant, whether using the logical channel prioritization, a delay-aware prioritize, or other prioritization mechanism specified at a later point. The network in some embodiments, for example, configures each LCID with zero or more prioritization mechanisms, e.g., via RRC signaling. The network may then indicate the prioritization mechanism that applies for a given grant, e.g., using a Physical Downlink Control Channel (PDCCH) indication. Depending on the RRC configuration and the PDCCH indication, the MAC at the UE selects the eligible LCIDs from which data will be taken and to which the indicated prioritization mechanism will apply.

Certain embodiments may provide one or more of the following technical advantage(s). Some embodiments enable the communication network to flexibly tell the UE which prioritization mechanism to use for a given grant, optimizing the resources for each of the configure services. This may lead to better network resource utilization and may assist to better meet the QoS of the different users and services.

More particularly, in some embodiments, there exist several different prioritization methods for the UE to utilize a grant, e.g., delay aware or logical channel prioritization. Such prioritization methods exemplify the prioritization algorithms described in FIG. 1. This disclosure introduces several options that can be used to indicate to the UE which prioritization method to use for a given LCID or queue, and the priority order of the prioritizations methods.

In one option, the network may configure each LCID with an associated prioritization method. This method will then later be used by the UE to select the LCID and buffers to fill the grant.

The network may at the same time also configure an execution order of the prioritization methods, an execution alpha value. If there are several LCIDs and some are configured with a special prioritization mechanism, e.g., some delay-aware and others with the standard logical channel prioritization, the UE will then allocate resources to the LCIDs in the configured execution order of the corresponding associated prioritization methods. Thus, the LCIDs that are associated with the prioritization method with the highest execution alpha value will be allocated resources first. If LCIDs use the same prioritization method, alternative if no execution order is configured, they are treated the same, i.e., allocated resources at the same time. Just as in legacy, there may be additional conditions which may be a requirement to qualify or disqualify a LCID to be selected.

In another option, the network provides an indication in the PDCCH, e.g., as an example of signaling 22 in FIG. 1. This indication may return 1) the prioritization mechanism to be used for the current grant and/or 2) the execution order of the different configured mechanisms. An indication on PDCCH can be done by adding new fields of corresponding downlink control information (DCI). This field can be a single bit to tell a UE a special grant for delay-aware scheduling or it can have multiple bits to explicitly indicate a wanted LCID to be prioritized.

### Execution Order:

If the RRC has configured the LCIDs with an associated prioritization mechanism (as described above), when the PDCCH is received, and the indication is provided the indication provides information about the execution order. A UE is, for example, configured with 4 LCIDs and two of them are configured with delay-aware scheduling, and the other two are configured with logical channel prioritization. If the PDCCH is received and a “delay-aware scheduling” indication is provided, the UE will select and allocate resources first to those LCIDs which were configured with “delay-aware scheduling”. There could be additional conditions the LCIDs may need to fulfill to be selected. Once these prioritized LCIDs have been completely served, the UE could select and allocate resources for other LCIDs configured with a different prioritization mechanism. Similarly, there may be additional conditions these LCIDs may need to fulfill to be selected.

### Prioritization Mechanism to be Used for the Current Grant:

Different scenarios are foreseen depending on whether RRC configures a LCID with none, one, or more than one prioritization mechanism. When PDCCH is received and the “prioritization mechanism” is indicated in PDCCH, this indication is passed to higher layers to assist selecting the “prioritization mechanism”, and/or setting the “prioritization mechanism”, and/or adding a condition to select the logical channels.

In the case when RRC configures a LCID with one associated prioritization mechanism, the MAC, when selecting the logical channels, only considers as eligible LCIDs which have been configured by RRC with the same prioritization mechanism as the indicated in PDCCH. If a LCID is not configured with the same prioritization mechanism as the indicated in PDCCH, it is not selected. Note that there could be additional conditions the LCIDs may need to fulfill to be finally selected.

If RRC configures a LCID with zero associated “prioritization mechanism”, i.e., the network does not associate the LCID with any concrete “prioritization mechanism” but is configured to act upon PDCCH indication carrying the “prioritization mechanism”, then the PDCCH indication sets the “prioritization mechanism” which will be apply to the LCID. The prioritization mechanism selected for the said LCID will be the one indicated in the PDCCH indication. An example can clarify the behavior. A UE is configured with 4 LCIDs. Two of them are configured with delay-aware scheduling and the other two are not explicitly configured with a prioritization mechanism. The PDCCH is received, and a “delay-aware scheduling” indication is provided. The MAC will set those LCIDs which had not been configured with any “prioritization mechanism” with the “prioritization mechanism” given by the PDCCH for the current grant. Then, the MAC will set as eligible the LCIDs which had the “prioritization mechanism” as indicated in PDCCH (as described in the previous paragraph). There could be additional conditions the LCIDs may need to fulfill to be finally selected.

The third scenario is that the network configures a LCID with multiple prioritization mechanisms and, optionally, a specific weight for each prioritization mechanism. In this case, when PDCCH provides an indication, this indication for the said LCID will determine which of all configured prioritization mechanisms is used for the current grant. A UE is, for example, configured with 4 LCIDs and two of them are configured with delay-aware scheduling, and the other two are configured with both “delay-aware scheduling” and “logical channel prioritization” mechanisms. If the PDCCH is received and a “delay-aware scheduling” indication is provided, the UE consider that “delay aware scheduling” applies to the two logical channels configured with multiple prioritization mechanism, one of them being “delay-aware scheduling”. Then, the MAC will consider eligible those LCIDs that match the indicated “prioritization mechanism”. The weight could add additional conditions to determine which “prioritization mechanism” applies at a given time. For example, a weight could be based on a buffer threshold. If the buffer is above a certain threshold, the prioritization mechanism which is to apply is one, and below a certain threshold is a second mechanism. In this case, UE behavior when the PDCCH is received is the same as in the first paragraph (one “prioritization mechanism” configured). Another weight could be packet delay budget left of the packets in the buffer.

Some of the solutions above assume the current Logical Channel ID framework i.e., the interface between radio link control (RLC) and MAC is the Logical Channel. However, a different framework could exist in which LCIDs are not defined. In this case, when LCIDs are not configured, a new PDCCH indication can be used for a buffer selection for resource allocation. A UE can make the selection of buffers based on legacy RRC conditions as mapping restriction and the PDDCH indication will be considered as additional condition for delay-aware scheduling.

Instead of PDCCH, delay-aware scheduling indication can also be included in configured grant configurations if used. In this case, the legacy configured grant configuration in MAC control element (CE) or RRC signaling will include indication for delay-scheduling prioritization and a receiving MAC entity can also allocate resources to a configured grant by the above mentioned prioritization procedure. Instead of indicating in MAC CE or RRC, the activation signaling of configured grant via PDCCH can be also used.

Note that LCID and buffer can be used inter-changeably in this context.

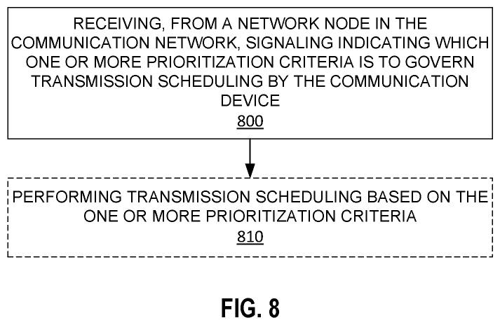

In view of the modifications and variations herein, FIG. 8 depicts a performed by a communication device 12 configured for use in a communication network 10. The method comprises receiving, from a network node 14 in the communication network 10, signaling indicating which one or more prioritization criteria 17 is to govern transmission scheduling by the communication device 12 (Block 800). In some embodiments, the signaling indicates this on a transmission grant by transmission grant basis.

In some embodiments, the one or more prioritization criteria 17 are respectively associated with one or more prioritization algorithms. In this case, the signaling 22 indicates according to which one or more prioritization algorithms the communication device 12 is to perform transmission scheduling. In one or more of these embodiments, the one or more prioritization algorithms include a logical channel prioritization algorithm and a delay-aware prioritization algorithm.

In some embodiments, the signaling 22 indicates which one or more prioritization criteria 17 is to govern transmission scheduling at a medium access control, MAC, layer or at a MAC entity of the communication device 12.

In some embodiments, the method further comprises receiving, from the network node 14, a grant for a transmission. In some embodiments, the signaling 22 indicates which one or more prioritization criteria 17 is to govern scheduling of the transmission for the grant.

In some embodiments, each logical channel or buffer is associated with one or more prioritization criteria 17. The method may further comprise selecting one or more logical channels or buffers to which to allocate resources for the transmission by selecting one or more logical channels or buffers that are associated with at least one of the one or more prioritization criteria 17 indicated by the signaling 22.

In some embodiments, the method further comprises determining, for each logical channel or buffer, a prioritization criteria 17 that is associated with that logical channel or buffer. The method in this case may also comprise selecting one or more logical channels or buffers to which to allocate resources for the transmission by selecting one or more logical channels or buffers that are associated with one of the one or more prioritization criteria 17 indicated by the signaling 22. In some embodiments where the signaling 22 indicates one or more thresholds, said determining may be based on the one or more thresholds. In one or more embodiments, for example, the one or more thresholds comprise one or more buffer thresholds or one or more packet delay budget left thresholds. In some embodiments, said determining comprises, for each logical channel or buffer that is able to be associated with multiple prioritization criteria 17, selecting one of the multiple prioritization criteria 17 to associate with the logical channel or buffer, based on the one or more thresholds.

In some embodiments, the signaling 22 indicates a priority ordering of the one or more prioritization criteria 17. In one or more of these embodiments, each logical channel or buffer is associated with one or more prioritization criteria 17. In some embodiments, the method further comprises receiving, from the network node 14, a grant for a transmission. In some embodiments, the method further comprises allocating resources to the one or more logical channels or buffers for the transmission, in descending priority order according to the priority ordering indicated by the signaling 22. In some embodiments, resources are allocated to any logical channel or buffer associated with a prioritization criteria 17 that has a higher priority before resources are allocated to any logical channel or buffer associated with a prioritization criteria 17 that has a lower priority.

In some embodiments, the method further comprises receiving, from the network node 14, signaling 22 indicating, for each of one or more logical channels or buffers, one or more prioritization criteria 17 associated with that logical channel or buffer. The method further comprises receiving, from the network node 14, a grant for a transmission. In some embodiments, the signaling 22 indicates which one or more prioritization criteria 17 is to govern scheduling of the transmission for the grant. The method further comprises for any logical channel or buffer for which the received signaling 22 does not indicate one or more prioritization criteria 17 associated with that logical channel or buffer, associating the logical channel or buffer with the one or more prioritization criteria 17 that is to govern scheduling of the transmission for the grant.

In some embodiments, the signaling 22 comprises physical layer signaling.

In some embodiments, the signaling 22 comprises an indication on a Physical Downlink Control Channel, PDCCH.

In some embodiments, the signaling 22 indicates which one or more prioritization criteria 17 is to govern transmission scheduling by the communication device 12 by indicating which one or more prioritization criteria 17 is to govern selection of one or more logical channels to which to allocate transmission resources. Additionally or alternatively, the signaling 22 indicates which one or more prioritization criteria 17 is to govern transmission scheduling by the communication device 12 by indicating which one or more prioritization criteria 17 is to govern allocation of resources across one or more selected logical channels.

In some embodiments, the signaling 22 indicates which one or more prioritization criteria 17 is to govern transmission scheduling by the communication device 12 by indicating which one or more prioritization criteria 17 is to govern selection of one or more buffers to which to allocate transmission resources. Additionally or alternatively, the signaling 22 indicates which one or more prioritization criteria 17 is to govern transmission scheduling by the communication device 12 by indicating which one or more prioritization criteria 17 is to govern allocation of resources across one or more selected buffers.

In some embodiments, the method further comprises receiving, from the network node 14, signaling 22 indicating, for each of one or more logical channels or buffers, one or more prioritization criteria 17 associated with that logical channel or buffer. In one or more of these embodiments, the signaling 22 is radio resource control, RRC, signaling.

In some embodiments, the method further comprises performing transmission scheduling based on the one or more prioritization criteria 17 (Block 810).

In some embodiments, the method further comprises performing scheduling of the transmission based on the one or more prioritization criteria 17.

FIG. 9 shows a method performed by a communication device 12 configured for use in a communication network 10 in accordance with other embodiments. The method comprises receiving, from a network node 14 in the communication network 10, signaling 22 that indicates, for each of one or more logical channels or buffers, one or more prioritization criteria 17 associated with that logical channel or buffer (Block 920).

In some embodiments, the signaling 22 is radio resource control, RRC, signaling.

In some embodiments, the method further comprises performing transmission scheduling based on the signaling 22 (Block 910).

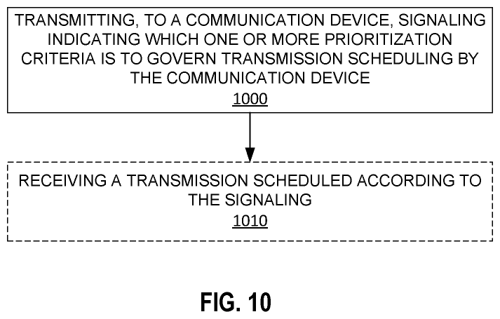

FIG. 10 shows a method performed by a network node 14 configured for use in a communication network 10. The method comprises transmitting, to a communication device 12, signaling 22 indicating which one or more prioritization criteria 17 is to govern transmission scheduling by the communication device 12 (Block 1000). In some embodiments, the signaling 22 indicates this on a transmission grant by transmission grant basis.

In some embodiments, the one or more prioritization criteria 17 are respectively associated with one or more prioritization algorithms. In this case, the signaling 22 indicates according to which one or more prioritization algorithms the communication device 12 is to perform transmission scheduling. In one or more of these embodiments, the one or more prioritization algorithms include a logical channel prioritization algorithm and a delay-aware prioritization algorithm.

In some embodiments, the signaling 22 indicates which one or more prioritization criteria 17 is to govern transmission scheduling at a medium access control, MAC, layer or at a MAC entity of the communication device 12.

In some embodiments, the method further comprises transmitting, to the communication device 12, a grant for a transmission. In this case, the signaling 22 indicates which one or more prioritization criteria 17 is to govern scheduling of the transmission for the grant. In one or more of these embodiments, each logical channel or buffer is associated with one or more prioritization criteria 17. In one or more of these embodiments, the signaling 22 indicates one or more thresholds based on which the communication device 12 is to determine a prioritization criteria 17 that is to be associated with each logical channel or buffer. In one or more of these embodiments, the one or more thresholds comprise one or more buffer thresholds or one or more packet delay budget left thresholds.

In some embodiments, the signaling 22 indicates a priority ordering of the one or more prioritization criteria 17.

In some embodiments, the signaling 22 comprises physical layer signaling.

In some embodiments, the signaling 22 comprises an indication on a Physical Downlink Control Channel, PDCCH.

In some embodiments, the signaling 22 indicates which one or more prioritization criteria 17 is to govern transmission scheduling by the communication device 12 by indicating which one or more prioritization criteria 17 is to govern selection of one or more logical channels to which to allocate transmission resources. Additionally or alternatively, the signaling 22 indicates which one or more prioritization criteria 17 is to govern transmission scheduling by the communication device 12 by indicating which one or more prioritization criteria 17 is to govern allocation of resources across one or more selected logical channels.

In some embodiments, the signaling 22 indicates which one or more prioritization criteria 17 is to govern transmission scheduling by the communication device 12 by indicating which one or more prioritization criteria 17 is to govern selection of one or more buffers to which to allocate transmission resources. Additionally or alternatively, the signaling 22 indicates which one or more prioritization criteria 17 is to govern transmission scheduling by the communication device 12 by indicating which one or more prioritization criteria 17 is to govern allocation of resources across one or more selected buffers.

In some embodiments, the method further comprises transmitting, to the communication device 12, signaling indicating, for each of one or more logical channels or buffers, one or more prioritization criteria 17 associated with that logical channel or buffer. In one or more of these embodiments, the signaling is radio resource control, RRC, signaling.

Other embodiments herein include a method performed by a network node 14 configured for use in a communication network 10. The method comprises transmitting, to a communication device 12, signaling that indicates, for each of one or more logical channels or buffers, one or more prioritization criteria 17 associated with that logical channel or buffer.

In some embodiments, the signaling is radio resource control, RRC, signaling.

Embodiments herein also include corresponding apparatuses. Embodiments herein for instance include a communication device 12 configured to perform any of the steps of any of the embodiments described above for the communication device 12.

Embodiments also include a communication device 12 comprising processing circuitry and power supply circuitry. The processing circuitry is configured to perform any of the steps of any of the embodiments described above for the communication device 12. The power supply circuitry is configured to supply power to the communication device 12.

Embodiments further include a communication device 12 comprising processing circuitry. The processing circuitry is configured to perform any of the steps of any of the embodiments described above for the communication device 12. In some embodiments, the communication device 12 further comprises communication circuitry.

Embodiments further include a communication device 12 comprising processing circuitry and memory. The memory contains instructions executable by the processing circuitry whereby the communication device 12 is configured to perform any of the steps of any of the embodiments described above for the communication device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the communication device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 14 configured to perform any of the steps of any of the embodiments described above for the network node 14.

Embodiments also include a network node 14 comprising processing circuitry and power supply circuitry. The processing circuitry is configured to perform any of the steps of any of the embodiments described above for the network node 14. The power supply circuitry is configured to supply power to the network node 14.

Embodiments further include a network node 14 comprising processing circuitry. The processing circuitry is configured to perform any of the steps of any of the embodiments described above for the network node 14. In some embodiments, the network node 14 further comprises communication circuitry.

Embodiments further include a network node 14 comprising processing circuitry and memory. The memory contains instructions executable by the processing circuitry whereby the network node 14 is configured to perform any of the steps of any of the embodiments described above for the network node 14.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

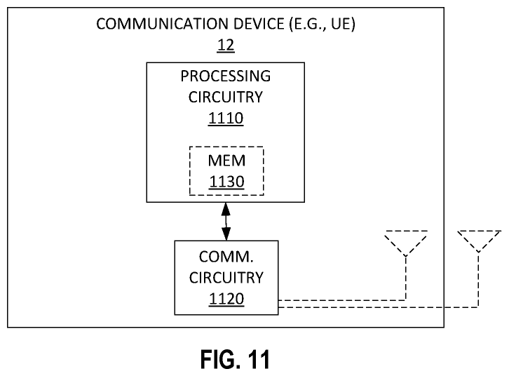

FIG. 11 for example illustrates a communication device 12 as implemented in accordance with one or more embodiments. As shown, the communication device 12 includes processing circuitry 1110 and communication circuitry 1120. The communication circuitry 1120 (e.g., radio circuitry) is configured to transmit and/or receive information to and/or from one or more other nodes, e.g., via any communication technology. Such communication may occur via one or more antennas that are either internal or external to the communication device 12. The processing circuitry 1110 is configured to perform processing described above, e.g., in FIG. 8 and/or FIG. 9, such as by executing instructions stored in memory 1130. The processing circuitry 1110 in this regard may implement certain functional means, units, or modules.

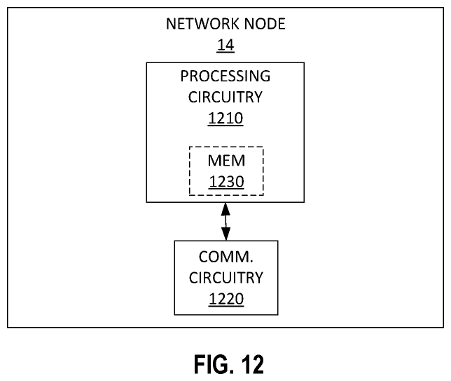

FIG. 12 illustrates a network node 14 as implemented in accordance with one or more embodiments. As shown, the network node 14 includes processing circuitry 1210 and communication circuitry 1220. The communication circuitry 1220 is configured to transmit and/or receive information to and/or from one or more other nodes, e.g., via any communication technology. The processing circuitry 1210 is configured to perform processing described above, e.g., in FIG. 10, such as by executing instructions stored in memory 1230. The processing circuitry 1210 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

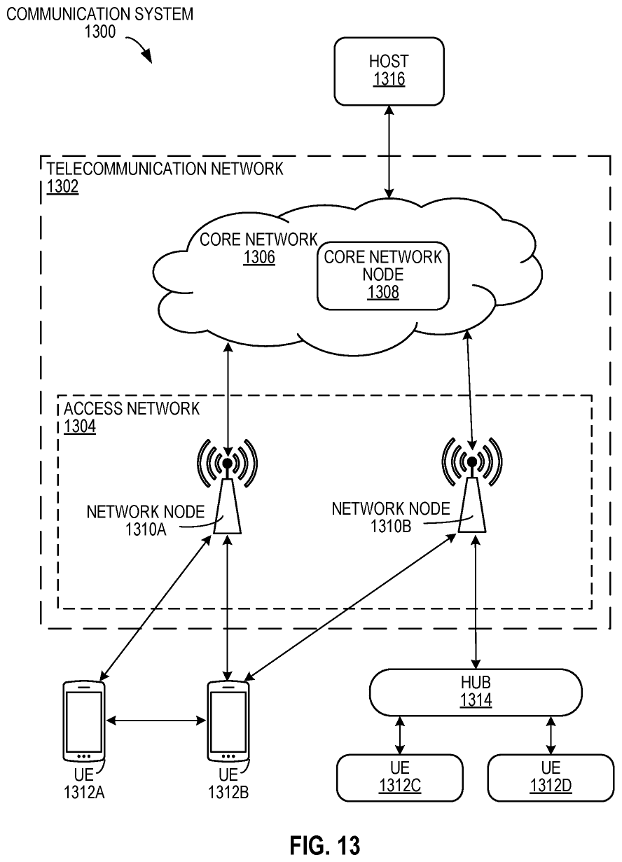

FIG. 13 shows an example of a communication system 1300 in accordance with some embodiments.

In the example, the communication system 1300 includes a telecommunication network 1302 that includes an access network 1304, such as a radio access network (RAN), and a core network 1306, which includes one or more core network nodes 1308. The access network 1304 includes one or more access network nodes, such as network nodes 1310a and 1310b (one or more of which may be generally referred to as network nodes 1310), or any other similar 3rd Generation Partnership Project (3GPP) access node or non-3GPP access point. The network nodes 1310 facilitate direct or indirect connection of user equipment (UE), such as by connecting UEs 1312a, 1312b, 1312c, and 1312d (one or more of which may be generally referred to as UEs 1312) to the core network 1306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1300 may include any number of wired or wireless networks, network nodes, UEs, and/or any other components or systems that may facilitate or participate in the communication of data and/or signals whether via wired or wireless connections. The communication system 1300 may include and/or interface with any type of communication, telecommunication, data, cellular, radio network, and/or other similar type of system.

The UEs 1312 may be any of a wide variety of communication devices, including wireless devices arranged, configured, and/or operable to communicate wirelessly with the network nodes 1310 and other communication devices. Similarly, the network nodes 1310 are arranged, capable, configured, and/or operable to communicate directly or indirectly with the UEs 1312 and/or with other network nodes or equipment in the telecommunication network 1302 to enable and/or provide network access, such as wireless network access, and/or to perform other functions, such as administration in the telecommunication network 1302.

In the depicted example, the core network 1306 connects the network nodes 1310 to one or more hosts, such as host 1316. These connections may be direct or indirect via one or more intermediary networks or devices. In other examples, network nodes may be directly coupled to hosts. The core network 1306 includes one more core network nodes (e.g., core network node 1308) that are structured with hardware and software components. Features of these components may be substantially similar to those described with respect to the UEs, network nodes, and/or hosts, such that the descriptions thereof are generally applicable to the corresponding components of the core network node 1308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1316 may be under the ownership or control of a service provider other than an operator or provider of the access network 1304 and/or the telecommunication network 1302, and may be operated by the service provider or on behalf of the service provider. The host 1316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1300 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1302 is a cellular network that implements 3GPP standardized features. Accordingly, the telecommunications network 1302 may support network slicing to provide different logical networks to different devices that are connected to the telecommunication network 1302. For example, the telecommunications network 1302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1312 are configured to transmit and/or receive information without direct human interaction. For instance, a UE may be designed to transmit information to the access network 1304 on a predetermined schedule, when triggered by an internal or external event, or in response to requests from the access network 1304. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1314 communicates with the access network 1304 to facilitate indirect communication between one or more UEs (e.g., UE 1312c and/or 1312d) and network nodes (e.g., network node 1310b). In some examples, the hub 1314 may be a controller, router, content source and analytics, or any of the other communication devices described herein regarding UEs. For example, the hub 1314 may be a broadband router enabling access to the core network 1306 for the UEs. As another example, the hub 1314 may be a controller that sends commands or instructions to one or more actuators in the UEs. Commands or instructions may be received from the UEs, network nodes 1310, or by executable code, script, process, or other instructions in the hub 1314. As another example, the hub 1314 may be a data collector that acts as temporary storage for UE data and, in some embodiments, may perform analysis or other processing of the data. As another example, the hub 1314 may be a content source. For example, for a UE that is a VR headset, display, loudspeaker or other media delivery device, the hub 1314 may retrieve VR assets, video, audio, or other media or data related to sensory information via a network node, which the hub 1314 then provides to the UE either directly, after performing local processing, and/or after adding additional local content. In still another example, the hub 1314 acts as a proxy server or orchestrator for the UEs, in particular in if one or more of the UEs are low energy IoT devices.

The hub 1314 may have a constant/persistent or intermittent connection to the network node 1310b. The hub 1314 may also allow for a different communication scheme and/or schedule between the hub 1314 and UEs (e.g., UE 1312c and/or 1312d), and between the hub 1314 and the core network 1306. In other examples, the hub 1314 is connected to the core network 1306 and/or one or more UEs via a wired connection. Moreover, the hub 1314 may be configured to connect to an M2M service provider over the access network 1304 and/or to another UE over a direct connection. In some scenarios, UEs may establish a wireless connection with the network nodes 1310 while still connected via the hub 1314 via a wired or wireless connection. In some embodiments, the hub 1314 may be a dedicated hub—that is, a hub whose primary function is to route communications to/from the UEs from/to the network node 1310b. In other embodiments, the hub 1314 may be a non-dedicated hub—that is, a device which is capable of operating to route communications between the UEs and network node 1310b, but which is additionally capable of operating as a communication start and/or end point for certain data channels.

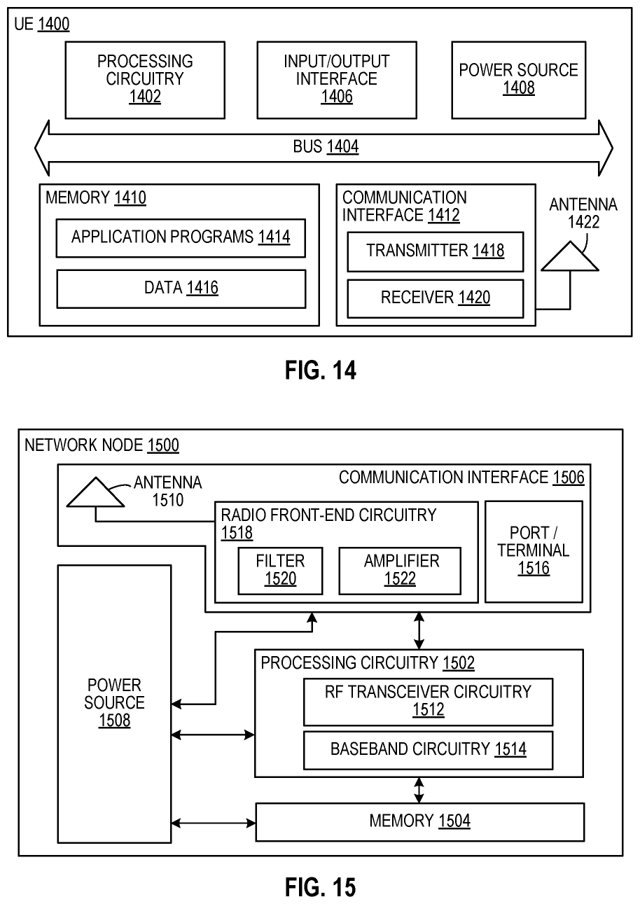

FIG. 14 shows a UE 1400 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1400 includes processing circuitry 1402 that is operatively coupled via a bus 1404 to an input/output interface 1406, a power source 1408, a memory 1410, a communication interface 1412, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry 1402 is configured to process instructions and data and may be configured to implement any sequential state machine operative to execute instructions stored as machine-readable computer programs in the memory 1410. The processing circuitry 1402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1402 may include multiple central processing units (CPUs).

In the example, the input/output interface 1406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1408 is structured as a battery or battery pack. Other types of power sources, such as an external power source (e.g., an electricity outlet), photovoltaic device, or power cell, may be used. The power source 1408 may further include power circuitry for delivering power from the power source 1408 itself, and/or an external power source, to the various parts of the UE 1400 via input circuitry or an interface such as an electrical power cable. Delivering power may be, for example, for charging of the power source 1408. Power circuitry may perform any formatting, converting, or other modification to the power from the power source 1408 to make the power suitable for the respective components of the UE 1400 to which power is supplied.

The memory 1410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1410 includes one or more application programs 1414, such as an operating system, web browser application, a widget, gadget engine, or other application, and corresponding data 1416. The memory 1410 may store, for use by the UE 1400, any of a variety of various operating systems or combinations of operating systems.

The memory 1410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1410 may allow the UE 1400 to access instructions, application programs and the like, stored on transitory or non-transitory memory media, to off-load data, or to upload data. An article of manufacture, such as one utilizing a communication system may be tangibly embodied as or in the memory 1410, which may be or comprise a device-readable storage medium.

The processing circuitry 1402 may be configured to communicate with an access network or other network using the communication interface 1412. The communication interface 1412 may comprise one or more communication subsystems and may include or be communicatively coupled to an antenna 1422. The communication interface 1412 may include one or more transceivers used to communicate, such as by communicating with one or more remote transceivers of another device capable of wireless communication (e.g., another UE or a network node in an access network). Each transceiver may include a transmitter 1418 and/or a receiver 1420 appropriate to provide network communications (e.g., optical, electrical, frequency allocations, and so forth). Moreover, the transmitter 1418 and receiver 1420 may be coupled to one or more antennas (e.g., antenna 1422) and may share circuit components, software or firmware, or alternatively be implemented separately.

In the illustrated embodiment, communication functions of the communication interface 1412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1400 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node 1500 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1500 includes a processing circuitry 1502, a memory 1504, a communication interface 1506, and a power source 1508. The network node 1500 may be composed of multiple physically separate components (e.g., a NodeB component and a RNC component, or a BTS component and a BSC component, etc.), which may each have their own respective components. In certain scenarios in which the network node 1500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1500 may be configured to support multiple radio access technologies (RATs). In such embodiments, some components may be duplicated (e.g., separate memory 1504 for different RATs) and some components may be reused (e.g., a same antenna 1510 may be shared by different RATs). The network node 1500 may also include multiple sets of the various illustrated components for different wireless technologies integrated into network node 1500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1500.

The processing circuitry 1502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1500 components, such as the memory 1504, to provide network node 1500 functionality.

In some embodiments, the processing circuitry 1502 includes a system on a chip (SOC). In some embodiments, the processing circuitry 1502 includes one or more of radio frequency (RF) transceiver circuitry 1512 and baseband processing circuitry 1514. In some embodiments, the radio frequency (RF) transceiver circuitry 1512 and the baseband processing circuitry 1514 may be on separate chips (or sets of chips), boards, or units, such as radio units and digital units. In alternative embodiments, part or all of RF transceiver circuitry 1512 and baseband processing circuitry 1514 may be on the same chip or set of chips, boards, or units.

The memory 1504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1502. The memory 1504 may store any suitable instructions, data, or information, including a computer program, software, an application including one or more of logic, rules, code, tables, and/or other instructions capable of being executed by the processing circuitry 1502 and utilized by the network node 1500. The memory 1504 may be used to store any calculations made by the processing circuitry 1502 and/or any data received via the communication interface 1506. In some embodiments, the processing circuitry 1502 and memory 1504 is integrated.

The communication interface 1506 is used in wired or wireless communication of signaling and/or data between a network node, access network, and/or UE. As illustrated, the communication interface 1506 comprises port(s)/terminal(s) 1516 to send and receive data, for example to and from a network over a wired connection. The communication interface 1506 also includes radio front-end circuitry 1518 that may be coupled to, or in certain embodiments a part of, the antenna 1510. Radio front-end circuitry 1518 comprises filters 1520 and amplifiers 1522. The radio front-end circuitry 1518 may be connected to an antenna 1510 and processing circuitry 1502. The radio front-end circuitry may be configured to condition signals communicated between antenna 1510 and processing circuitry 1502. The radio front-end circuitry 1518 may receive digital data that is to be sent out to other network nodes or UEs via a wireless connection. The radio front-end circuitry 1518 may convert the digital data into a radio signal having the appropriate channel and bandwidth parameters using a combination of filters 1520 and/or amplifiers 1522. The radio signal may then be transmitted via the antenna 1510. Similarly, when receiving data, the antenna 1510 may collect radio signals which are then converted into digital data by the radio front-end circuitry 1518. The digital data may be passed to the processing circuitry 1502. In other embodiments, the communication interface may comprise different components and/or different combinations of components.

In certain alternative embodiments, the network node 1500 does not include separate radio front-end circuitry 1518, instead, the processing circuitry 1502 includes radio front-end circuitry and is connected to the antenna 1510. Similarly, in some embodiments, all or some of the RF transceiver circuitry 1512 is part of the communication interface 1506. In still other embodiments, the communication interface 1506 includes one or more ports or terminals 1516, the radio front-end circuitry 1518, and the RF transceiver circuitry 1512, as part of a radio unit (not shown), and the communication interface 1506 communicates with the baseband processing circuitry 1514, which is part of a digital unit (not shown).

The antenna 1510 may include one or more antennas, or antenna arrays, configured to send and/or receive wireless signals. The antenna 1510 may be coupled to the radio front-end circuitry 1518 and may be any type of antenna capable of transmitting and receiving data and/or signals wirelessly. In certain embodiments, the antenna 1510 is separate from the network node 1500 and connectable to the network node 1500 through an interface or port.

The antenna 1510, communication interface 1506, and/or the processing circuitry 1502 may be configured to perform any receiving operations and/or certain obtaining operations described herein as being performed by the network node. Any information, data and/or signals may be received from a UE, another network node and/or any other network equipment. Similarly, the antenna 1510, the communication interface 1506, and/or the processing circuitry 1502 may be configured to perform any transmitting operations described herein as being performed by the network node. Any information, data and/or signals may be transmitted to a UE, another network node and/or any other network equipment.

The power source 1508 provides power to the various components of network node 1500 in a form suitable for the respective components (e.g., at a voltage and current level needed for each respective component). The power source 1508 may further comprise, or be coupled to, power management circuitry to supply the components of the network node 1500 with power for performing the functionality described herein. For example, the network node 1500 may be connectable to an external power source (e.g., the power grid, an electricity outlet) via an input circuitry or interface such as an electrical cable, whereby the external power source supplies power to power circuitry of the power source 1508. As a further example, the power source 1508 may comprise a source of power in the form of a battery or battery pack which is connected to, or integrated in, power circuitry. The battery may provide backup power should the external power source fail.

Embodiments of the network node 1500 may include additional components beyond those shown in FIG. 15 for providing certain aspects of the network node's functionality, including any of the functionality described herein and/or any functionality necessary to support the subject matter described herein. For example, the network node 1500 may include user interface equipment to allow input of information into the network node 1500 and to allow output of information from the network node 1500. This may allow a user to perform diagnostic, maintenance, repair, and other administrative functions for the network node 1500.

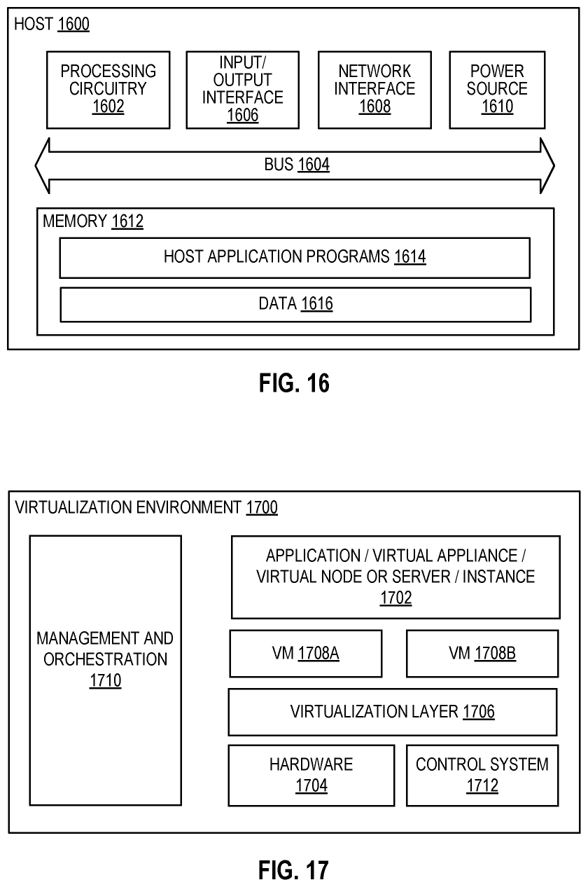

FIG. 16 is a block diagram of a host 1600, which may be an embodiment of the host 1316 of FIG. 13, in accordance with various aspects described herein. As used herein, the host 1600 may be or comprise various combinations hardware and/or software, including a standalone server, a blade server, a cloud-implemented server, a distributed server, a virtual machine, container, or processing resources in a server farm. The host 1600 may provide one or more services to one or more UEs.

The host 1600 includes processing circuitry 1602 that is operatively coupled via a bus 1604 to an input/output interface 1606, a network interface 1608, a power source 1610, and a memory 1612. Other components may be included in other embodiments. Features of these components may be substantially similar to those described with respect to the devices of previous figures, such as FIGS. 14 and 15, such that the descriptions thereof are generally applicable to the corresponding components of host 1600.

The memory 1612 may include one or more computer programs including one or more host application programs 1614 and data 1616, which may include user data, e.g., data generated by a UE for the host 1600 or data generated by the host 1600 for a UE. Embodiments of the host 1600 may utilize only a subset or all of the components shown. The host application programs 1614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1614 may also provide for user authentication and licensing checks and may periodically report health, routes, and content availability to a central node, such as a device in or on the edge of a core network. Accordingly, the host 1600 may select and/or indicate a different host for over-the-top services for a UE. The host application programs 1614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 17 is a block diagram illustrating a virtualization environment 1700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1702 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1706 (also referred to as hypervisors or virtual machine monitors (VMMs)), provide VMs 1708a and 1708b (one or more of which may be generally referred to as VMs 1708), and/or perform any of the functions, features and/or benefits described in relation with some embodiments described herein. The virtualization layer 1706 may present a virtual operating platform that appears like networking hardware to the VMs 1708.

The VMs 1708 comprise virtual processing, virtual memory, virtual networking or interface and virtual storage, and may be run by a corresponding virtualization layer 1706. Different embodiments of the instance of a virtual appliance 1702 may be implemented on one or more of VMs 1708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1708 may be a software implementation of a physical machine that runs programs as if they were executing on a physical, non-virtualized machine. Each of the VMs 1708, and that part of hardware 1704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1708 on top of the hardware 1704 and corresponds to the application 1702.

Hardware 1704 may be implemented in a standalone network node with generic or specific components. Hardware 1704 may implement some functions via virtualization. Alternatively, hardware 1704 may be part of a larger cluster of hardware (e.g. such as in a data center or CPE) where many hardware nodes work together and are managed via management and orchestration 1710, which, among others, oversees lifecycle management of applications 1702. In some embodiments, hardware 1704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1712 which may alternatively be used for communication between hardware nodes and radio units.

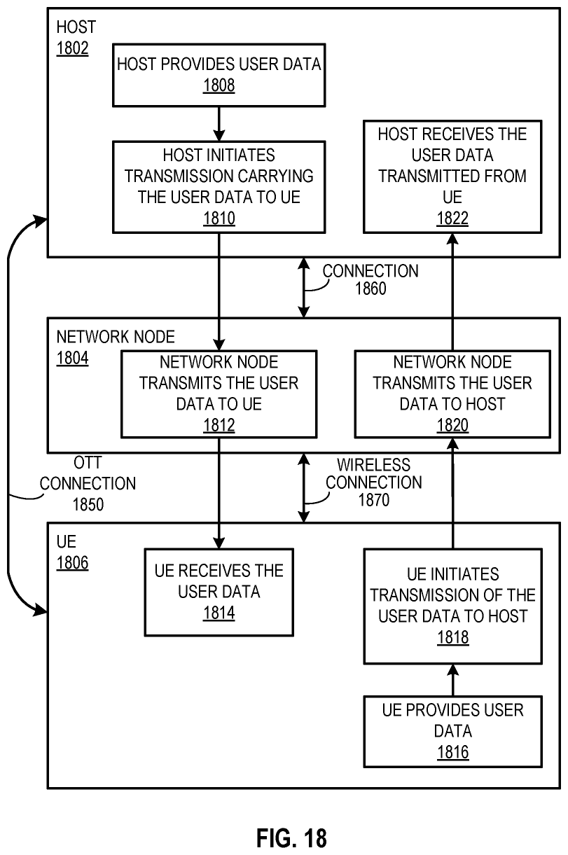

FIG. 18 shows a communication diagram of a host 1802 communicating via a network node 1804 with a UE 1806 over a partially wireless connection in accordance with some embodiments. Example implementations, in accordance with various embodiments, of the UE (such as a UE 1312a of FIG. 13 and/or UE 1400 of FIG. 14), network node (such as network node 1310a of FIG. 13 and/or network node 1500 of FIG. 15), and host (such as host 1316 of FIG. 13 and/or host 1600 of FIG. 16) discussed in the preceding paragraphs will now be described with reference to FIG. 18.

Like host 1600, embodiments of host 1802 include hardware, such as a communication interface, processing circuitry, and memory. The host 1802 also includes software, which is stored in or accessible by the host 1802 and executable by the processing circuitry. The software includes a host application that may be operable to provide a service to a remote user, such as the UE 1806 connecting via an over-the-top (OTT) connection 1850 extending between the UE 1806 and host 1802. In providing the service to the remote user, a host application may provide user data which is transmitted using the OTT connection 1850.

The network node 1804 includes hardware enabling it to communicate with the host 1802 and UE 1806. The connection 1860 may be direct or pass through a core network (like core network 1306 of FIG. 13) and/or one or more other intermediate networks, such as one or more public, private, or hosted networks. For example, an intermediate network may be a backbone network or the Internet.

The UE 1806 includes hardware and software, which is stored in or accessible by UE 1806 and executable by the UE's processing circuitry. The software includes a client application, such as a web browser or operator-specific “app” that may be operable to provide a service to a human or non-human user via UE 1806 with the support of the host 1802. In the host 1802, an executing host application may communicate with the executing client application via the OTT connection 1850 terminating at the UE 1806 and host 1802. In providing the service to the user, the UE's client application may receive request data from the host's host application and provide user data in response to the request data. The OTT connection 1850 may transfer both the request data and the user data. The UE's client application may interact with the user to generate the user data that it provides to the host application through the OTT connection 1850.

The OTT connection 1850 may extend via a connection 1860 between the host 1802 and the network node 1804 and via a wireless connection 1870 between the network node 1804 and the UE 1806 to provide the connection between the host 1802 and the UE 1806. The connection 1860 and wireless connection 1870, over which the OTT connection 1850 may be provided, have been drawn abstractly to illustrate the communication between the host 1802 and the UE 1806 via the network node 1804, without explicit reference to any intermediary devices and the precise routing of messages via these devices.

As an example of transmitting data via the OTT connection 1850, in step 1808, the host 1802 provides user data, which may be performed by executing a host application. In some embodiments, the user data is associated with a particular human user interacting with the UE 1806. In other embodiments, the user data is associated with a UE 1806 that shares data with the host 1802 without explicit human interaction. In step 1810, the host 1802 initiates a transmission carrying the user data towards the UE 1806. The host 1802 may initiate the transmission responsive to a request transmitted by the UE 1806. The request may be caused by human interaction with the UE 1806 or by operation of the client application executing on the UE 1806. The transmission may pass via the network node 1804, in accordance with the teachings of the embodiments described throughout this disclosure. Accordingly, in step 1812, the network node 1804 transmits to the UE 1806 the user data that was carried in the transmission that the host 1802 initiated, in accordance with the teachings of the embodiments described throughout this disclosure. In step 1814, the UE 1806 receives the user data carried in the transmission, which may be performed by a client application executed on the UE 1806 associated with the host application executed by the host 1802.

In some examples, the UE 1806 executes a client application which provides user data to the host 1802. The user data may be provided in reaction or response to the data received from the host 1802. Accordingly, in step 1816, the UE 1806 may provide user data, which may be performed by executing the client application. In providing the user data, the client application may further consider user input received from the user via an input/output interface of the UE 1806. Regardless of the specific manner in which the user data was provided, the UE 1806 initiates, in step 1818, transmission of the user data towards the host 1802 via the network node 1804. In step 1820, in accordance with the teachings of the embodiments described throughout this disclosure, the network node 1804 receives user data from the UE 1806 and initiates transmission of the received user data towards the host 1802. In step 1822, the host 1802 receives the user data carried in the transmission initiated by the UE 1806.

One or more of the various embodiments improve the performance of OTT services provided to the UE 1806 using the OTT connection 1850, in which the wireless connection 1870 forms the last segment.

In an example scenario, factory status information may be collected and analyzed by the host 1802. As another example, the host 1802 may process audio and video data which may have been retrieved from a UE for use in creating maps. As another example, the host 1802 may collect and analyze real-time data to assist in controlling vehicle congestion (e.g., controlling traffic lights). As another example, the host 1802 may store surveillance video uploaded by a UE. As another example, the host 1802 may store or control access to media content such as video, audio, VR or AR which it can broadcast, multicast or unicast to UEs. As other examples, the host 1802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1850 between the host 1802 and UE 1806, in response to variations in the measurement results. The measurement procedure and/or the network functionality for reconfiguring the OTT connection may be implemented in software and hardware of the host 1802 and/or UE 1806. In some embodiments, sensors (not shown) may be deployed in or in association with other devices through which the OTT connection 1850 passes; the sensors may participate in the measurement procedure by supplying values of the monitored quantities exemplified above, or supplying values of other physical quantities from which software may compute or estimate the monitored quantities. The reconfiguring of the OTT connection 1850 may include message format, retransmission settings, preferred routing etc.; the reconfiguring need not directly alter the operation of the network node 1804. Such procedures and functionalities may be known and practiced in the art. In certain embodiments, measurements may involve proprietary UE signaling that facilitates measurements of throughput, propagation times, latency and the like, by the host 1802. The measurements may be implemented in that software causes messages to be transmitted, in particular empty or ‘dummy’ messages, using the OTT connection 1850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Example embodiments of the techniques and apparatus described herein include, but are not limited to, the following enumerated examples:

### Group A Embodiments

A1. A method performed by a communication device configured for use in a communication network, the method comprising:
receiving, from a network node in the communication network, signaling indicating which one or more prioritization criteria is to govern transmission scheduling by the communication device.
   A2. The method of embodiment A1, wherein the one or more prioritization criteria are respectively associated with one or more prioritization algorithms, wherein the signaling indicates according to which one or more prioritization algorithms the communication device is to perform transmission scheduling.
   A3. The method of embodiment A2, wherein the one or more prioritization algorithms include a logical channel prioritization algorithm and a delay-aware prioritization algorithm.
   A4. The method of any of embodiments A1-A3, wherein the signaling indicates which one or more prioritization criteria is to govern transmission scheduling at a medium access control, MAC, layer or at a MAC entity of the communication device.
   A5. The method of any of embodiments A1-A4, further comprising receiving, from the network node, a grant for a transmission, wherein the signaling indicates which one or more prioritization criteria is to govern scheduling of the transmission for the grant.
   A6. The method of embodiment A5, wherein each logical channel or buffer is associated with one or more prioritization criteria, wherein the method further comprises selecting one or more logical channels or buffers to which to allocate resources for the transmission by selecting one or more logical channels or buffers that are associated with at least one of the one or more prioritization criteria indicated by the signaling.
   A7. The method of embodiment A5, further comprising:
determining, for each logical channel or buffer, a prioritization criteria that is associated with that logical channel or buffer; and
selecting one or more logical channels or buffers to which to allocate resources for the transmission by selecting one or more logical channels or buffers that are associated with one of the one or more prioritization criteria indicated by the signaling.
   A8. The method of embodiment A7, wherein the signaling indicates one or more thresholds, wherein said determining is based on the one or more thresholds.
   A9. The method of embodiment A8, wherein the one or more thresholds comprise one or more buffer thresholds or one or more packet delay budget left thresholds.
   A10. The method of any of embodiments A8-A9, wherein said determining comprises, for each logical channel or buffer that is able to be associated with multiple prioritization criteria, selecting one of the multiple prioritization criteria to associate with the logical channel or buffer, based on the one or more thresholds.
   A11. The method of any of embodiments A1-A10, wherein the signaling indicates a priority ordering of the one or more prioritization criteria.
   A12. The method of embodiment A12, wherein each logical channel or buffer is associated with one or more prioritization criteria, wherein the method further comprises:
receiving, from the network node, a grant for a transmission; and
allocating resources to the one or more logical channels or buffers for the transmission, in descending priority order according to the priority ordering indicated by the signaling, wherein resources are allocated to any logical channel or buffer associated with a prioritization criteria that has a higher priority before resources are allocated to any logical channel or buffer associated with a prioritization criteria that has a lower priority.
   A13. The method of any of embodiments A1-A12, further comprising:
receiving, from the network node, signaling indicating, for each of one or more logical channels or buffers, one or more prioritization criteria associated with that logical channel or buffer;
receiving, from the network node, a grant for a transmission, wherein the signaling indicates which one or more prioritization criteria is to govern scheduling of the transmission for the grant;
for any logical channel or buffer for which the received signaling does not indicate one or more prioritization criteria associated with that logical channel or buffer, associating the logical channel or buffer with the one or more prioritization criteria that is to govern scheduling of the transmission for the grant.
   A14. The method of any of embodiments A1-A13, wherein the signaling comprises physical layer signaling.
   A15. The method of any of embodiments A1-A15, wherein the signaling comprises an indication on a Physical Downlink Control Channel, PDCCH.
   A16. The method of any of embodiments A1-A15, wherein the signaling indicates which one or more prioritization criteria is to govern transmission scheduling by the communication device by indicating:
which one or more prioritization criteria is to govern selection of one or more logical channels to which to allocate transmission resources; and/or
which one or more prioritization criteria is to govern allocation of resources across one or more selected logical channels.
   A17. The method of any of embodiments A1-A15, wherein the signaling indicates which one or more prioritization criteria is to govern transmission scheduling by the communication device by indicating:
which one or more prioritization criteria is to govern selection of one or more buffers to which to allocate transmission resources; and/or
which one or more prioritization criteria is to govern allocation of resources across one or more selected buffers.
   A18. The method of any of embodiments A1-A17, further comprising receiving, from the network node, signaling indicating, for each of one or more logical channels or buffers, one or more prioritization criteria associated with that logical channel or buffer.
   A19. The method of embodiment A18, wherein the signaling is radio resource control, RRC, signaling.
   A20. The method of any of embodiments A1-A19, further comprising performing transmission scheduling based on the one or more prioritization criteria.
   A21. The method of embodiment A5, further comprising performing scheduling of the transmission based on the one or more prioritization criteria.
   AA1. A method performed by a communication device configured for use in a communication network, the method comprising:
receiving, from a network node in the communication network, signaling that indicates, for each of one or more logical channels or buffers, one or more prioritization criteria associated with that logical channel or buffer.
   AA2. The method of embodiment AA1, wherein the signaling is radio resource control, RRC, signaling.
   AA3. The method of any of embodiments AA1-AA2, further comprising performing transmission scheduling based on the signaling.
   AA. The method of any of the previous embodiments, further comprising:
providing user data; and forwarding the user data to a host computer via the transmission to a base station.

### Group B Embodiments

B1. A method performed by a network node configured for use in a communication network, the method comprising:
transmitting, to a communication device, signaling indicating which one or more prioritization criteria is to govern transmission scheduling by the communication device.
   B2. The method of embodiment B1, wherein the one or more prioritization criteria are respectively associated with one or more prioritization algorithms, wherein the signaling indicates according to which one or more prioritization algorithms the communication device is to perform transmission scheduling.
   B3. The method of embodiment B2, wherein the one or more prioritization algorithms include a logical channel prioritization algorithm and a delay-aware prioritization algorithm.
   B4. The method of any of embodiments B1-B3, wherein the signaling indicates which one or more prioritization criteria is to govern transmission scheduling at a medium access control, MAC, layer or at a MAC entity of the communication device.
   B5. The method of any of embodiments B1-B4, further comprising transmitting, to the communication device, a grant for a transmission, wherein the signaling indicates which one or more prioritization criteria is to govern scheduling of the transmission for the grant.
   B6. The method of embodiment B5, wherein each logical channel or buffer is associated with one or more prioritization criteria.
   B7. The method of embodiment B6, wherein the signaling indicates one or more thresholds based on which the communication device is to determine a prioritization criteria that is to be associated with each logical channel or buffer.
   B8. The method of embodiment B7, wherein the one or more thresholds comprise one or more buffer thresholds or one or more packet delay budget left thresholds.
   B9. The method of any of embodiments B1-B8, wherein the signaling indicates a priority ordering of the one or more prioritization criteria.
   B10. The method of any of embodiments B1-B9, wherein the signaling comprises physical layer signaling.
   B11. The method of any of embodiments B1-B10, wherein the signaling comprises an indication on a Physical Downlink Control Channel, PDCCH.
   B12. The method of any of embodiments B1-B11, wherein the signaling indicates which one or more prioritization criteria is to govern transmission scheduling by the communication device by indicating:
which one or more prioritization criteria is to govern selection of one or more logical channels to which to allocate transmission resources; and/or
which one or more prioritization criteria is to govern allocation of resources across one or more selected logical channels.
   B13. The method of any of embodiments B1-B11, wherein the signaling indicates which one or more prioritization criteria is to govern transmission scheduling by the communication device by indicating:
which one or more prioritization criteria is to govern selection of one or more buffers to which to allocate transmission resources; and/or
which one or more prioritization criteria is to govern allocation of resources across one or more selected buffers.
   B14. The method of any of embodiments B1-B13, further comprising transmitting, to the communication device, signaling indicating, for each of one or more logical channels or buffers, one or more prioritization criteria associated with that logical channel or buffer.
   B15. The method of embodiment B14, wherein the signaling is radio resource control, RRC, signaling.
   BB1. A method performed by a network node configured for use in a communication network, the method comprising:
transmitting, to a communication device, signaling that indicates, for each of one or more logical channels or buffers, one or more prioritization criteria associated with that logical channel or buffer.
   BB2. The method of embodiment BB1, wherein the signaling is radio resource control, RRC, signaling.
   BB. The method of any of the previous embodiments, further comprising:
obtaining user data; and
forwarding the user data to a host computer or a wireless communication device.

### Group C Embodiments

C1. A communication device configured to perform any of the steps of any of the Group A embodiments.
C2. A communication device comprising processing circuitry configured to perform any of the steps of any of the Group A embodiments.
C3. A communication device comprising:
communication circuitry; and
processing circuitry configured to perform any of the steps of any of the Group A embodiments.
   C4. A communication device comprising:
processing circuitry configured to perform any of the steps of any of the Group A embodiments; and
power supply circuitry configured to supply power to the communication device.
   C5. A communication device comprising:
processing circuitry and memory, the memory containing instructions executable by the processing circuitry whereby the communication device is configured to perform any of the steps of any of the Group A embodiments.
   C6. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.
   C7. A computer program comprising instructions which, when executed by at least one processor of a communication device, causes the communication device to carry out the steps of any of the Group A embodiments.
   C8. A carrier containing the computer program of embodiment C7, wherein the carrier is one of an electronic signal, optical signal, radio signal, or computer readable storage medium.
   C9. A network node configured to perform any of the steps of any of the Group B embodiments.
   C10. A network node comprising processing circuitry configured to perform any of the steps of any of the Group B embodiments.
   C11. A network node comprising:
communication circuitry; and
processing circuitry configured to perform any of the steps of any of the Group B embodiments.
   C12. A network node comprising:
processing circuitry configured to perform any of the steps of any of the Group B embodiments;
power supply circuitry configured to supply power to the network node.
   C13. A network node comprising:
processing circuitry and memory, the memory containing instructions executable by the processing circuitry whereby the network node is configured to perform any of the steps of any of the Group B embodiments.
   C14. The network node of any of embodiments C9-C13, wherein the network node is a base station.
   C15. A computer program comprising instructions which, when executed by at least one processor of a network node, causes the network node to carry out the steps of any of the Group B embodiments.
   C16. The computer program of embodiment C14, wherein the network node is a base station.
   C17. A carrier containing the computer program of any of embodiments C15-C16, wherein the carrier is one of an electronic signal, optical signal, radio signal, or computer readable storage medium.

### Group D Embodiments

D1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.
   D2. The communication system of the previous embodiment further including the base station.
   D3. The communication system of the previous 2 embodiments, further including the UE, wherein the UE is configured to communicate with the base station.
   D4. The communication system of the previous 3 embodiments, wherein:
the processing circuitry of the host computer is configured to execute a host application, thereby providing the user data; and
the UE comprises processing circuitry configured to execute a client application associated with the host application.
   D5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.
   D6. The method of the previous embodiment, further comprising, at the base station, transmitting the user data.
   D7. The method of the previous 2 embodiments, wherein the user data is provided at the host computer by executing a host application, the method further comprising, at the UE, executing a client application associated with the host application.
   D8. A user equipment (UE) configured to communicate with a base station, the UE comprising a radio interface and processing circuitry configured to perform any of the previous 3 embodiments.
   D9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.
   D10. The communication system of the previous embodiment, wherein the cellular network further includes a base station configured to communicate with the UE.
   D11. The communication system of the previous 2 embodiments, wherein:
the processing circuitry of the host computer is configured to execute a host application, thereby providing the user data; and
the UE's processing circuitry is configured to execute a client application associated with the host application.
   D12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.
   D13. The method of the previous embodiment, further comprising at the UE, receiving the user data from the base station.
   D14. A communication system including a host computer comprising:
communication interface configured to receive user data originating from a transmission from a user equipment (UE) to a base station, wherein the UE comprises a radio interface and processing circuitry, the UE's processing circuitry configured to perform any of the steps of any of the Group A embodiments.
   D15. The communication system of the previous embodiment, further including the UE.
   D16. The communication system of the previous 2 embodiments, further including the base station, wherein the base station comprises a radio interface configured to communicate with the UE and a communication interface configured to forward to the host computer the user data carried by a transmission from the UE to the base station.
   D17. The communication system of the previous 3 embodiments, wherein:
the processing circuitry of the host computer is configured to execute a host application; and
the UE's processing circuitry is configured to execute a client application associated with the host application, thereby providing the user data.
   D18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.
   D19. A method implemented in a communication system including a host computer, a base station and a user equipment (UE), the method comprising:
at the host computer, receiving user data transmitted to the base station from the UE, wherein the UE performs any of the steps of any of the Group A embodiments.
   D20. The method of the previous embodiment, further comprising, at the UE, providing the user data to the base station.
   D21. The method of the previous 2 embodiments, further comprising:
at the UE, executing a client application, thereby providing the user data to be transmitted; and
at the host computer, executing a host application associated with the client application.
   D22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.
   D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
   D24. The communication system of the previous embodiment further including the base station.
   D25. The communication system of the previous 2 embodiments, further including the UE, wherein the UE is configured to communicate with the base station.
   D26. The communication system of the previous 3 embodiments, wherein:
the processing circuitry of the host computer is configured to execute a host application;
the UE is configured to execute a client application associated with the host application, thereby providing the user data to be received by the host computer.
   D27. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.
   D28. The method of the previous embodiment, further comprising at the base station, receiving the user data from the UE.
   D29. The method of the previous 2 embodiments, further comprising at the base station, initiating a transmission of the received user data to the host computer.

1. A method performed by a communication device configured for use in a communication network, the method comprising:
receiving, from a network node in the communication network, signaling indicating, on a transmission grant by transmission grant basis, which one or more prioritization criteria is to govern transmission scheduling by the communication device; and
performing transmission scheduling according to the signaling.

2. The method of claim 1, wherein the signaling is physical layer signaling.

3. The method of claim 1, wherein the signaling indicates, on a transmission grant by transmission grant basis, which one or more prioritization criteria is to govern transmission scheduling by the communication device by indicating, on a transmission grant by transmission grant basis one or both of:
which one or more prioritization criteria is to govern selection of one or more logical channels to which to allocate transmission resources; and
which one or more prioritization criteria is to govern allocation of resources across one or more selected logical channels.

4. The method of claim 1, wherein multiple prioritization criteria are configurable to govern transmission scheduling by the communication device, wherein the signaling indicates, on a transmission grant by transmission grant basis, which one of the multiple prioritization criteria is to govern transmission scheduling by the communication device, and wherein the multiple prioritization criteria include logical channel priority and time budget remaining.

5. The method of claim 1, wherein the one or more prioritization criteria are respectively associated with one or more prioritization algorithms, wherein the signaling indicates, on a transmission grant by transmission grant basis, according to which one or more prioritization algorithms the communication device is to perform transmission scheduling.

6. The method of claim 5, wherein the one or more prioritization algorithms include a logical channel prioritization algorithm and a delay-aware prioritization algorithm.

7. The method of claim 1, further comprising receiving, from the network node, a grant for a transmission, wherein the signaling is specific to the grant and indicates which one or more prioritization criteria is to govern scheduling of the transmission for the grant, and wherein said performing comprises performing scheduling of the transmission according to the signaling.

8. The method of claim 7, further comprising:
determining, for each logical channel or buffer, a prioritization criteria that is associated with that logical channel or buffer; and
selecting one or more logical channels or buffers to which to allocate resources for the transmission by selecting one or more logical channels or buffers that are associated with one of the one or more prioritization criteria indicated by the signaling.

9. The method of claim 8, further comprising receiving, from the network node, further signaling indicating, for each of one or more logical channels or buffers, one or more prioritization criteria associated with that logical channel or buffer, and wherein said determining is based on the further signaling.

10. The method of claim 1, wherein the signaling indicates, on a transmission grant by transmission grant basis, a priority ordering of the one or more prioritization criteria, wherein each logical channel or buffer is associated with one or more prioritization criteria, wherein the method further comprises:
receiving, from the network node, a grant for a transmission; and
allocating resources to one or more logical channels or buffers for the transmission, in descending priority order according to the priority ordering indicated by the signaling, wherein resources are allocated to any logical channel or buffer associated with a prioritization criteria that has a higher priority before resources are allocated to any logical channel or buffer associated with a prioritization criteria that has a lower priority.

11. A method performed by a network node configured for use in a communication network, the method comprising:
transmitting, to a communication device, signaling indicating, on a transmission grant by transmission grant basis, which one or more prioritization criteria is to govern transmission scheduling by the communication device.

12. (canceled)

13. The method of claim 11, wherein the signaling indicates, on a transmission grant by transmission grant basis, which one or more prioritization criteria is to govern transmission scheduling by the communication device by indicating, on a transmission grant by transmission grant basis one or both of:
which one or more prioritization criteria is to govern selection of one or more logical channels to which to allocate transmission resources; and
which one or more prioritization criteria is to govern allocation of resources across one or more selected logical channels.

14. The method of claim 11, wherein multiple prioritization criteria are configurable to govern transmission scheduling by the communication device, wherein the signaling indicates, on a transmission grant by transmission grant basis, which one of the multiple prioritization criteria is to govern transmission scheduling by the communication device, and wherein the multiple prioritization criteria include logical channel priority and time budget remaining.

15. The method of claim 11, wherein the one or more prioritization criteria are respectively associated with one or more prioritization algorithms, wherein the signaling indicates, on a transmission grant by transmission grant basis, according to which one or more prioritization algorithms the communication device is to perform transmission scheduling.

16. The method of claim 15, wherein the one or more prioritization algorithms include a logical channel prioritization algorithm and a delay-aware prioritization algorithm.

17. The method of claim 11, further comprising transmitting, to the communication device, a grant for a transmission, wherein the signaling is specific to the grant and indicates which one or more prioritization criteria is to govern scheduling of the transmission for the grant.

18. The method of claim 11, wherein the signaling indicates a priority ordering of the one or more prioritization criteria.

19. The method of claim 11, further comprising transmitting, to the communication device, further signaling indicating, for each of one or more logical channels or buffers, one or more prioritization criteria associated with that logical channel or buffer.

20.-26. (canceled)

27. A communication device configured for use in a communication network, the communication device comprising:
communication circuitry; and
processing circuitry configured to:
receive, from a network node in the communication network via the communication circuitry, signaling indicating, on a transmission grant by transmission grant basis, which one or more prioritization criteria is to govern transmission scheduling by the communication device; and
perform transmission scheduling according to the signaling.

28. (canceled)

29. A network node configured for use in a communication network, the network node comprising:
communication circuitry; and
processing circuitry configured to transmit, to a communication device using the communication circuitry, signaling indicating, on a transmission grant by transmission grant basis, which one or more prioritization criteria is to govern transmission scheduling by the communication device.

30.-51. (canceled)
